(19) United States
(12) Patent Application Publication
(10) Pub. No.: US 2022/0141000 A1
(43) Pub. Date: May 5, 2022

(54) INFORMATION PROCESSING APPARATUS, SECURE COMPUTATION METHOD, AND PROGRAM

(71) Applicant: NEC Corporation, Minato-ku, Tokyo (JP)

(72) Inventors: Hikaru TSUCHIDA, Tokyo (JP); Toshinori ARAKI, Tokyo (JP); Kazuma OHARA, Tokyo (JP); Takuma AMADA, Tokyo (JP)

(73) Assignee: NEC Corporation, Minato-ku, Tokyo (JP)

(21) Appl. No.: 17/430,507

(22) PCT Filed: Feb. 12, 2019
(86) PCT No.: PCT/JP2019/004794

§ 371 Date: Aug. 12, 2021

(51) Int. Cl. H04L 9/08; H04L 9/00

(52) U.S. Cl. CPC H04L 9/085; H04L 9/002; H04L 9/0869

(57) ABSTRACT

An information processing apparatus that performs bit embedding processing by four-party MPC using 2-out-of-4 replicated secret sharing stores a seed to generate a random number used when performing an operation concerning shares, generates, by using the seed, share reconstruction data for reconstructing a share used when performing bit embedding, and constructs a share for bit embedding by using at least the share reconstruction data.

This application is a National Stage Entry of PCT/JP2019/004794 filed on Feb. 12, 2019, the contents of all of which are incorporated herein by reference, in their entirety.

### FIELD

The present invention relates to an information processing apparatus, a secure computation method, and a program. In particular, the present invention relates to an information processing apparatus, a secure computation method, and a program/non-transitory medium concerning bit embedding in four-party secure computation which enables to detect fraud.

### BACKGROUND

In recent years, research and development on secure computation have been actively carried out. In the secure computation, it is possible to perform predetermined processing with input data kept secret to obtain a result.

Secure computation protocols are broadly divided into two types. A first scheme is a secure computation protocol in which only for specific computation can be executed. A second scheme is a secure computation protocol in which any computation can be executed. There are various schemes under the second scheme, and trade-offs may be established between schemes in cost such as a communication amount (data volume) and the number of communication rounds. For example, there is a scheme in which a communication amount is small but the number of communication rounds is large and another scheme in which a communication amount is large but the number of communication rounds is small.

As a typical secure computation protocol, there is a Multi Party Computation (MPC). MPC is a secure computation protocol which enables to compute an arbitrary function among a plurality of participants while keeping input of each participant to be secret. There are several schemes in MPC, and a scheme which attracts attention in recent years is an MPC based on secret sharing. In the MPC based on secret sharing, input is shared by (distributed to) each of participants. Here, shared data is called a share. Each participant computes a target function using each share in cooperation among the participants. At this time, because, with respect to a value under a computation process, a form of a share is maintained, an original input and a value under a computation process are never revealed. Only a share of a final computation result is restored, whereby an arbitrary function can be securely computed. Hereinafter, a share of a value of x∈ [symbol] ₂_{ⁿ}, where n≥2, is denoted as [x]ⁿ, while for n=1, a share of a value of x∈ [symbol] ₂ is denoted as [x]. It is noted that [symbol] ₂ⁿ={0, 1, . . . , 2ⁿ−1} and [symbol] ={0,1} are rings of integer modulo 2ⁿ and 2, respectively.

There are broadly two items of safety which MPC achieves. One is secrecy. The other is correctness. Secrecy is safety to ensure [symbol] for participants that information concerning input is not leaked when executing MPC even if there exists an assumed adversary. Correctness is safety to ensure that an execution result is correct when a secure computation protocol is executed even if there exists an assumed adversary.

There are several indexes for the “assumed adversary” described above. As a typical index, a first is a behavior of an adversary. A second is a ratio of adversaries in participants.

When focusing on behavior of an adversary, as typical types of adversaries, there are a semi-honest adversary and a malicious adversary. A semi-honest adversary is an adversary who tries to increase information available within an extent possible while following a protocol. A malicious adversary is an adversary who tries to increase information available thereto by performing behavior deviating from a protocol. Here, the behavior deviating from a protocol is, for example, to falsify transmission data by performing bit inversion on data to be originally transmitted.

When focusing on a ratio of adversaries in participants, there are broadly two types. One is a case where there exists a Dishonest majority. The other is a case where there exists an Honest majority. Where, let total the number of participants be n and let the number of adversaries be t. The case where a majority is a Dishonest majority means a case where t<n holds. The case where a majority is an Honest majority means a case where t<n/2 holds. Although the case where a majority is an Honest majority includes a case where t<n/3 holds, in this description, the case where a majority is an Honest majority is to be a case where t<n/2 holds, if not particularly mentioned.

In recent years, there exists three-party MPC as MPC attracting attention. NPL 1 discloses three-party MPC in a case where there exists an Honest majority and an adversary is a Semi-honest Adversary. MPC disclosed in NPL (Non Patent Literature) 1 realizes an arithmetic operation on [symbol] ₂_{ⁿ}. MPC disclosed in NPL 1 requires a communication cost of 3n bits per multiplication on [symbol] ₂_{ⁿ}. That is, a multiplication can be realized by a communication cost of n bits per participant.

NPL 2 discloses three-party MPC in a case where there exists an Honest majority and an adversary is a Malicious Adversary. This is a scheme based on a scheme of NPL 1. MPC disclosed in NPL 2 is different from MPC disclosed in NPL 1 in that it allows existence of a Malicious Adversary. In the MPC disclosed in NPL 2, it is possible to probabilistically detect fraud by a Malicious Adversary. The higher detection probability, that is, the lower probability of successful fraud is attempted, the higher communication cost will result. For example, if a probability of successful fraud is 2⁻⁴⁰, in NPL 2, communication cost of 21n bits is required per multiplication on [symbol] ₂_{ⁿ}. That is, a multiplication with a fraud detection function can be realized by communication cost of 7n bits per participant.

In NPL 3, a method of bit embedding processing to a share in NPL 1 is proposed. Bit embedding is, for example, to obtain a share of [x]ⁿ (x∈ [symbol] ₂) from [x]. Such processing is important processing when it is desired to efficiently execute MPC for a mixed circuit in which an arithmetic circuit and a logical circuit are mixed. In particular, it is an important processing when a processing is branched using a result of condition determination. For example, when bit embedding processing proposed in NPL 3 is performed using a scheme of NPL 2, communication cost which can tolerate existence of a Malicious Adversary, is 42n bits·2 rounds.

In many cases, a communication cost becomes low in a case where there are few participants in MPC and there exists an Honest majority. Therefore, it has been considered that the three-party MPC as described above is a scheme with good calculation efficiency. However, if a possible adversary is a Malicious Adversary, there is a case where computation efficiency may be better in four-party MPC.

For example, NPL 4 discloses four-party MPC in a case where t<n/3, that is t=1 and an adversary is a Malicious Adversary. MPC disclosed in NPL 4 requires a communication cost of 6n bits per multiplication on [symbol] ₂_{ⁿ}. That is, multiplication can be realized by a communication cost of 1.5n bits per participant. However, NPL 4 does not propose bit embedding processing specific to the scheme. Because bit embedding disclosed in NPL 3 requires that a form of a share is to be a specific form, bit embedding processing disclosed in NPL 3 cannot be applied to the scheme disclosed in NPL 4.
NPL 1: T. Araki et al., “High-Throughput Semi-Honest Secure Three-Party Computation with an Honest Majority.”, 2016, In Proceedings of the 2016 ACM SIGSAC Conference on Computer and Communications Security (CCS '16). ACM, New York, N.Y., USA, 805-817.
NPL 2: T. Araki et al., “Optimized Honest-Majority MPC for Malicious Adversaries—Breaking the 1 Billion-Gate Per Second Barrier”, 2017, IEEE Symposium on Security and Privacy (SP), San Jose, Calif., USA, 2017, pp. 843-862.
NPL 3: Ohara, et al., “Different-Sized Rings Mixed Maliciously-Secure Multiparty Computation”, In SCIS 2018, 2A1-4.
NPL 4: S. Dov Gordon et al., “Secure Computation with Low Communication from Cross-checking., Cryptology ePrint Archive, Report 2018/216, 2018, https://eprint.iacr.org/2018/216.

### SUMMARY

Each disclosure of the above Non Patent Literatures is incorporated herein by reference thereto. The following analysis has been given by the present inventors.

A scheme in which a communication cost in performing MPC, is reduced as much as possible is desired to be realized. Although the communication cost includes communication traffic and the number of communication rounds, the communication traffic is especially important when a priority is placed on efficiency of the number of processing per unit time.

For example, four-party MPC, in a case where t<n/3, that is, t=1 and an adversary is a Malicious Adversary, can be realized by a communication cost of 5n bits per multiplication on [symbol] ₂_{ⁿ}. That is, multiplication can be realized by a communication cost of 1.25n bits per participant. This is a method using 2-out-of-4 replicated secret sharing.

Let P_i (i=1, . . . , 4) denote each participant.

Let's assume that a share of x∈ [symbol] ₂_{ⁿ}(n≥2) is

[x]ⁿ=([x]₁ⁿ,[x]₂ⁿ,[x]₃ⁿ,[x]₄ⁿ),

where [x]ᵢⁿ is a share of P_i.
Let's assume that a share of x∈ [symbol] ₂ is

[x]=([x]₁,[x]₂,[x]₃,[x]₄),

where [x]ᵢ is a share of P_i.
In this case, for x∈ [symbol] ₂_{ⁿ}(n≥2), if x=x₁+x₂+x₃, holds, then

[x]₁ⁿ=(x₁,x₂),[x]₂ⁿ=(x₂,x₃),[x]₃ⁿ=(x₃,x₁),[x]₄ⁿ=(x₁−x₂,x₂−x₃)

For x∈ [symbol] ₂, if x=x₁⊕x₂⊕x₃ holds, where ⊕ is an exclusive OR, then

[x]₁=(x₁,x₂),[x]₂=(x₂,x₃),[x]₃=(x₃,x₁),[x]₄=(x₁⊕x₂,x₂⊕x₃).

The followings are assumed.

seedᵢ,sid∈{0,1}*(i=1, 2, 3, 4), where sid is a session identifier.
A pseudo-random function is given as:

h:{0,1}*×{0,1}*→{0,1}

Let ∥ denote a character string concatenation operator.
P_1 includes (seed₁,seed₂,seed₄),
P_2 includes (seed₂,seed₃,seed₄),
P_3 includes (seed₃,seed₁,seed₄), and
P_4 includes (seed₁,seed₂,seed₃).

With respect to seedᵢ and sid, it is intended to create a situation in which one participant in participants cannot computes an output of h and the other three participants can compute the output of h. If this situation can be created, handling of seedᵢ and sid is not particularly limited. In the present description, seedᵢ and sid are just an example.

Let +, −, and · denote respectively an addition operator, a subtraction operator and a multiplication operator concerning shares on [symbol] ₂_{ⁿ} (n≥2). These operators are hereinafter used also as an addition operator, a subtraction operator and a multiplication operator, as binary operators for elements on [symbol] ₂_{ⁿ} (n≥2).

Regarding an addition operator and a subtraction operator for shares on [symbol] ₂_{ⁿ}(n≥2), a, b, c∈ [symbol] ₂_{ⁿ}, the following four equations hold.

[a]ⁿ+[b]ⁿ=[a+b]ⁿ

[a]ⁿ+c=[a+c]ⁿ

[a]ⁿ·[b]ⁿ=[a·b]ⁿ

[a]ⁿ·c=[a·c]ⁿ

Let ⊕ and · denote respectively an exclusive OR and a logical multiplication concerning shares on [symbol] ₂. These operators are hereinafter used also for an exclusive OR and a logical multiplication as binary operators for elements on [symbol] ₂.

Regarding an exclusive OR and a logical multiplication concerning share on [symbol] ₂, a, b, c∈ [symbol] ₂, the following four equations hold.

[a]⊕[b]=[a⊕b]

[a]⊕c=[a⊕c]

[a]·[b]=[a·b]

[a]·c=[a·c]

For example, in four-party MPC using 2-out-of-4 replicated secret sharing as described above, the followings hold.

$${[ a + b ]}_{1}^{n} = {( ( {a}_{1} + {b}_{1} ) , ( {a}_{2} + {b}_{2} ) ) \\ [ a + b ]}_{2}^{n} = {( ( {a}_{2} + {b}_{2} ) , ( {a}_{3} + {b}_{3} ) ) \\ [ a + b ]}_{3}^{n} = {( ( {a}_{3} + {b}_{3} ) , ( {a}_{1} + {b}_{1} ) ) \\ [ a + b ]}_{4}^{n} = ( ( {a}_{1} - {a}_{2} ) + ( {b}_{1} - {b}_{2} ) , ( {a}_{2} - {a}_{3} ) + ( {b}_{2} - {b}_{3} ) ) = ( ( {a}_{1} + {b}_{1} ) - ( {a}_{2} + {b}_{2} ) , ( {a}_{2} + {b}_{2} ) - ( {a}_{3} + {b}_{3} ) ) ,$$

From [a]ⁿ and [b]ⁿ, it is possible to compute [a+b]ⁿ.
Assuming c=a·b, it is possible to compute [c]ⁿ, using [a]ⁿ and [b]ⁿ, by the following procedure.

1. Each participant (P_1 to P3) respectively performs the following computation.

### P_1:

u₁=a₁·b₁+h(sid∥1,seed₄)

u₂=a₂·b₂+h(sid∥2,seed₄)

c₁=(a₁+a₂)·(b₁+b₂)−a₁·b₁+h(sid,seed₁)−h(sid,seed₂)−h(sid∥2,seed₄)+h(sid∥3,seed₄)

v₁=u₁−u₂

### P_2:

u₂=a₂·b₂+h(sid∥2,seed₄)

u₃=a₃·b₃+h(sid∥3,seed₄)

c₂=(a₂+a₃)·(b₂+b₃)−a₂·b₂+h(sid,seed₂)−h(sid,seed₃)−h(sid∥3,seed₄)+h(sid∥1,seed₄)

v₂=u₂−u₃

### P_3:

u₃=a₃·b₃+h(sid∥3,seed₄)

u₁=a₁·b₁+h(sid∥1,seed₄)

c₃=(a₃+a₁)·(b₃+b₁)−a₃·b₃+h(sid,seed₃)−h(sid,seed₁)−h(sid∥1,seed₄)+h(sid∥2,seed₄)

v₃=u₃−u₁

2. When above computation are finished, each participant perform the following communication.

P_1 transmits c₁ to P_3.

P_2 transmits c₂ to P_1.

P_3 transmits c₃ to P_2.

P_1 transmits v₁ to P_4.

P_2 transmits u₂ to P_4.

3. Each participant acquires [c]ᵢⁿ by the following computation using information acquired by the communications as described above.

[c]₁ⁿ=(c₁,c₂)

[c]₂ⁿ=(c₂,c₃)

[c]₃ⁿ=(c₃,c₁)

[c]₄ⁿ=(c₁−c₂,c₂−c₃)

A share of P_4 is computed in the following manner.

### P_4:

c₁−c₂=−(x₁−x₂)·(y₁−y₂)+(x₂−x₃)·(y₂−y₃)+v₂−v₃+h(sid,seed₁)−2·h(sid,seed₂)+h(sid,seed₃)

c₂−c₃=−(x₂−x₃)·(y₂−y₃)+(x₃−x₁)·(y₃−y₁)+v₃−v₁+h(sid,seed₂)−2·h(sid,seed₃)+h(sid,seed₁)

It is well-known for those skilled in the art concerning a multiplication of a share by a constant and an addition of a share with a constant, an explanation will be omitted. With respect to operations concerning shares on [symbol] ₂, description will be omitted because it can be executed in the same way as operations concerning shares on [symbol] ₂_{ⁿ}. At this time, even if there is one Malicious Adversary in participants, it is possible to verify whether or not values have been falsified using each own share and values received from different participants. If there is falsification, the protocol is aborted.

However, in the four-party MPC using a method using 2-out-of-4 replicated secret sharing described above, it is difficult to perform bit embedding (embedding). This is because a method disclosed in NPL 3 cannot be directly utilized because a form of a share is different. Therefore, if it is desired to efficiently perform calculation of a mixed circuit by MPC which enables to detect fraud, it is required to propose an efficient bit embedding processing which can be performed by four-party MPC disclosed in NPL 4 or four-party MPC using 2-out-of-4 replicated secret sharing as described above.

It is a main object of the present invention to provide an information processing apparatus, a secure computation method, and a non-transitory medium storing a program, each contributing to performing bit embedding processing in four-party MPC using the 2-out-of-4 replicated secret sharing.

According to a first aspect of the present invention or disclosure, there is provided an information processing apparatus that includes: a basic operation seed storage part that stores a seed to generate a random number used for performing an operation on a share; a share reconstruction data generation part that generates, by using the seed, share reconstruction data for reconstructing a share used when performing bit embedding; and a share construction part that constructs a share for bit embedding by using at least the share reconstruction data.

According to a second aspect of the present invention or disclosure, there is provided a secure computation method in an information processing apparatus that includes a basic operation seed storage part that stores a seed to generate a random number used when performing an operation on a share, the method including:

generating, by using the seed, share reconstruction data for reconstructing a share used when performing bit embedding; and

constructing a share for bit embedding by using at least the share reconstruction data.

According to a third aspect of the present invention or disclosure, there is provided a program that causes a computer mounted on an information processing apparatus that includes a basic operation seed storage part that stores a seed to generate a random number used when performing operation concerning shares, to execute processing including:

generating, by using the seed, share reconstruction data for reconstructing a share used when performing bit embedding; and

constructing a share for bit embedding by using at least the share reconstruction data. It is to be noted that this program can be recorded on a non-transitory computer-readable storage medium. The storage medium can be non-transient one, such as a semiconductor memory, a hard disk, a magnetic recording medium, an optical recording medium, and so on. The present invention can be implemented as a computer program product.

According to the present invention, an information processing apparatus, a secure computation method, and a program, each performing bit embedding processing which can be computed efficiently when computing a mixed circuit by the four-party MPC using 2-out-of-4 replicated secret sharing are provided.

### BRIEF DESCRIPTION OF DRAWINGS

FIG. 1 is a diagram illustrating an outline of an example embodiment.

FIG. 2 is a block diagram illustrating an example of a functional configuration of a bit embedding system according to a first example embodiment.

FIG. 3 is a block diagram illustrating a functional configuration of a server apparatus according to the first example embodiment.

FIG. 4 is a flowchart illustrating an example of an operation of a bit embedding system concerning bit embedding according to the first example embodiment.

FIG. 5 is a block diagram illustrating an example of a functional configuration of a bit embedding system according to a second example embodiment.

FIG. 6 is a block diagram illustrating a functional configuration of a server apparatus according to the second example embodiment.

FIG. 7 is a flowchart illustrating an example of an operation of a bit embedding system concerning bit embedding according to the second example embodiment.

FIG. 8 is a block diagram illustrating an example of a functional configuration of a bit embedding system according to a third example embodiment.

FIG. 9 is a block diagram illustrating a functional configuration of a server apparatus according to the third example embodiment.

FIG. 10 is a flowchart illustrating an example of an operation of a bit embedding system concerning bit embedding according to the third example embodiment.

FIG. 11 is a block diagram illustrating an example of a functional configuration of a bit embedding system according to a fourth example embodiment.

FIG. 12 is a block diagram illustrating a functional configuration of a server apparatus according to the fourth example embodiment.

FIG. 13 is a flowchart illustrating an example of an operation of a bit embedding system concerning bit embedding according to the fourth example embodiment.

FIG. 14 is a block diagram illustrating an example of a functional configuration of a bit embedding according to a fifth example embodiment.

FIG. 15 is a block diagram illustrating a functional configuration of a server apparatus according to the fifth example embodiment.

FIG. 16 is a flowchart illustrating an example of an operation of a bit embedding system concerning bit embedding according to the fifth example embodiment.

FIG. 17 is a diagram illustrating an example of a hardware configuration of a secure computation server apparatus.

### DETAILED DESCRIPTION

First, an outline of an example embodiment will be described. In the following outline, reference signs of the drawings are denoted to each element as an example for the sake of convenience to facilitate understanding and description of this outline is not intended to any limitation. An individual connection line between blocks in drawings and so on referred to in the following description includes both one-way and two-way directions. A one-way arrow schematically illustrates a principal signal (data) flow and does not exclude bidirectionality. Though not illustrated, an input port(s) and an output port(s) exist respectively at connection point of input/output of each connection line, in circuit diagrams, block diagrams, internal configuration diagrams and connection diagrams, and so on disclosed herein. The same applies to the input/output interfaces.

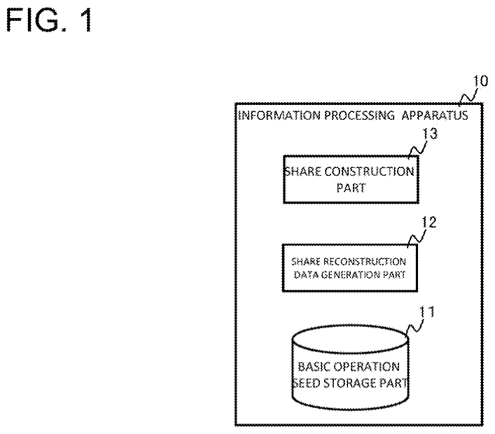

An information processing apparatus 10 according to an example embodiment includes a basic operation seed storage part 11, a share reconstruction data generation part 12, a share construction part 13 (refer to FIG. 1). The basic operation seed storage part 11 stores a seed to generate a random number used when performing an operation on shares. The share reconstruction data generation part 12 generates by using the seed, share reconstruction data for reconstructing a share used when performing bit embedding. The share construction part 13 constructs a share for bit embedding by using at least the share reconstruction data.

Here, although bit embedding is useful processing for efficiently performing secure computation also at four-party MPC, if a form of share which each apparatus holds is inconsistent, benefit therefrom cannot be obtained. Therefore, the information processing apparatus 10 as described above reconstruct a share in such way that the form of share which each apparatus holds is unified whereby bit embedding can be facilitated.

Specific example embodiments will be further described in more detail with reference to drawings in the below. The same reference signs are assigned to the same components in each example embodiment and the description thereof will be omitted.

### First Example Embodiment

The following describes a first example embodiment in more detail with reference to drawings.

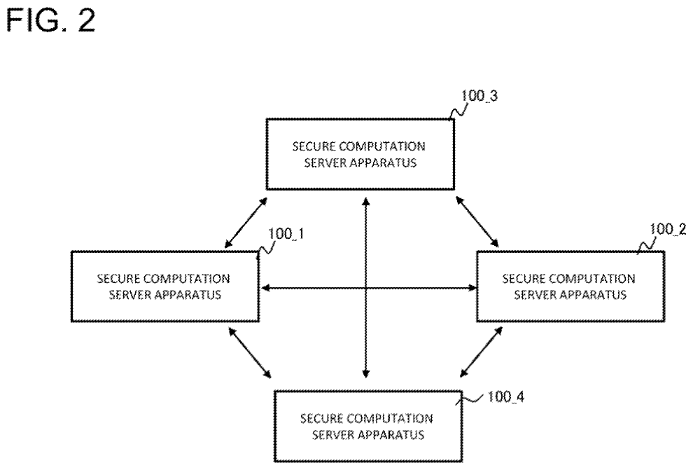

A bit embedding processing system according to a first example embodiment will be described with reference to FIG. 2 to FIG. 4.

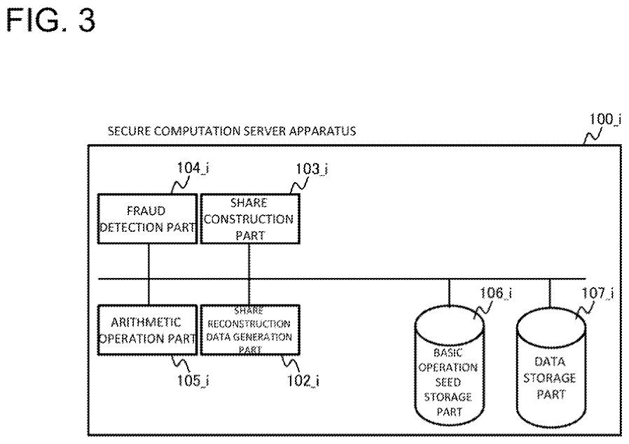

FIG. 2 is a block diagram illustrating an example of a functional configuration of the bit embedding processing system according to a first example embodiment. Referring to FIG. 2, the bit embedding processing system according to the first example embodiment includes an i-th (i=1, 2, 3, 4) secure computation server (hereinafter, simply described as a server apparatus) which will be referred to in FIG. 3 which will be explained below. In the bit embedding processing system according to the first example embodiment, each of server apparatuses 100_1, 100_2, 100_3, and 100_4 is communicatively connected to server apparatuses different from itself via a network.

FIG. 3 is a block diagram illustrating an example of a functional configuration of the i-th server apparatus 100_i (i=1, 2, 3, 4). As illustrated in FIG. 3, the i-th server apparatus 100_i includes an i-th share reconstruction data generation part 102_i, an i-th share construction part 103_i, an i-th fraud detection part 104_i, an i-th arithmetic operation part 105_i, an i-th basic operation seed storage part 106_i, and an i-th data storage part 107_1. Please note that the i-th share reconstruction data generation part 102_i, the i-th share construction part 103_i, the i-th fraud detection part 104_i, the i-th arithmetic operation part 105_i, the i-th basic operation seed storage part 106_i, and the i-th data storage part 107_i are respectively connected.

In the bit embedding processing system having the above configuration, with respect to a value which any of the first to fourth server apparatuses 100_1 to 100_4 provided, x∈ [symbol] ₂, or shares stored in the first to fourth data storage part 107_1 to 107_4, [x], or shares which has been inputted from outside thereof that is not the first to fourth server apparatuses 100_1 to 100_4, [x], without a value [x]ⁿ is computed and stored in the first to fourth data storage part 107_1 to 107_4.

With respect to shares of the above computation result, the shares may be transmitted and received by the first to fourth server apparatuses 100_1 to 100_4 and restored. Alternatively, shares may be transmitted to outside that is not the first to fourth server apparatuses 100_1 to 100_4 and restored.

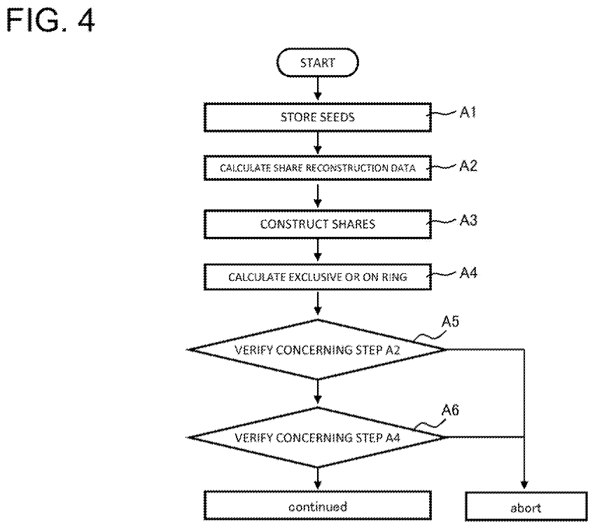

Next, an operation of the bit embedding processing system and the first to fourth server apparatuses 100_1 to 100_4 according to the first example embodiment will be described in detail. FIG. 4 is a flowchart illustrating an example of an operation concerning bit embedding of the first to fourth server apparatuses 100_1 to 100_4.

In the first example embodiment, it will be described for a case where bit embedding is performed to shares [x] of a value x on [symbol] ₂. In that case, each server apparatus 100_i generates data for computing (constructing), from a share [x] of a value x on [symbol] ₂, a share [x₂]ⁿ of a value x₂ and a share of [x₁⊕x₃]ⁿ of a value x₁⊕x₃ on [symbol] ₂_{ⁿ}.

Each server apparatus 100_i holds a share [x] of a value x on [symbol] ₂. For example, assuming that x=x₁⊕x₂⊕x₃, each server apparatus 100_i holds the following set of values.
The server apparatus 100_1: [x]₁=(x₁,x₂)
The server apparatus 100_2: [x]₂=(x₂,x₃)
The server apparatus 100_3: [x]₃=(x₃,x₁)
The server apparatus 100_4: [x]₄=(x₁⊕x₂, x₂⊕x₃).
For example, assuming that a value x=1, if x₁=1, x₂=0, and x₃=0, the server apparatus 100_1 holds (1, 0).
Under such situation, when performing the bit embedding,
from a share [x] of a value x on [symbol] ₂, a share [x₂]ⁿ of a value x₂ and a share [x₁⊕x₃]ⁿ of a value x₁⊕x₃, on [symbol] ₂_{ⁿ}, are computed.

### (Step A1)

Each basic operation seed storage part 106_1, 106_2, 106_3, 106_4 respectively stores

(seed₁,seed₂,seed₄),
(seed₂,seed₃,seed₄),
(seed₃,seed₁,seed₄),
(seed₁,seed₂,seed₃).

Each server apparatus 100_1 to 100_4 commonly shares pseudo-random functions h and h′.

### Where

seedᵢ∈{0,1}*(i=1,2,3)

the pseudo-random function is given as:

h:{0,1}*×{0,1}*→{0,1}ⁿ

Each data storage part 107_1 to 107_4 respectively stores

[x]₁=(x₁,x₂),[x]₂=(x₂,x₃),[x]₃=(x₃,x₁), and [x]₄=(x₁⊕x₂,x₂⊕x₃)

where [x]ᵢ(i=1, 2, 3, 4) is [x] stored in each data storage part 107_i.

It is intended to create a situation in which, with respect to seedᵢ, in the server apparatuses 100_i (i=1, 2, 3, 4), one participant cannot compute an output of h and other three participants can compute an output of h.

If this situation can be created, handling of seedᵢ is not particularly limited. In the present description, seedᵢ is just an example.

### (Step A2)

In step A2, the i-th share reconstruction data generation part 102_i generates data (share reconstruction data) for reconstructing a share used when performing bit embedding. More specifically, the i-th share reconstruction data generation part 102_i generates, from a share [x] of a value x on [symbol] ₂, data for computing (constructing) a share [x₂]ⁿ of a value x₂ and a share [x₁⊕x₃]ⁿ of x₁⊕x₃, on [symbol] ₂_{ⁿ}.

More specifically, the i-th share reconstruction data generation part 102_i generates a random number, when generating data for reconstructing a share of a value x (for example, a value x₂ as described above), such that two values out of x₁, x₂, and x₃ become equal, where x₁, x₂, and x₃ satisfy x=x₁+x₂+x₃ (i.e., x is a sum of three values). The i-th share reconstruction data generation part 102_i generates a random number r, when generating data for reconstructing a share of a value x′ (for example, x₁⊕x₃ as described above), such that letting r be a random number, x₁′=x′+r, x₂′=0, and x3′=−r hold, where x′=x1′+x2′+x3′.

The first share reconstruction data generation part 102_1, the second share reconstruction data generation part 102_2, and the third share reconstruction data generation part 102_3 acquire respectively seed₄ from the first basic operation seed storage part 106_1, the second basic operation seed storage part 106_2, and the third basic operation seed storage part 106_3.

Then, the first share reconstruction data generation part 102_1, the second share reconstruction data generation part 102_2, and the third share reconstruction data generation part 102_3 generate (compute) r=h(sid∥2,seed₄).

The first share reconstruction data generation part 102_1 stores r in the first data storage part 107_1.
The third share reconstruction data generation part 102_3 transmits r to the third share construction part 103_3.
The second share reconstruction data generation part 102_2 takes out x₂ from the second data storage part 107_2 and transmits x₂−3r to the fourth share construction part 103_4.

The second share reconstruction data generation part 102_2 acquires seed₃ from the second basic operation seed storage part 106_2.

The third share reconstruction data generation part 102_3 acquires seed₃ from the third basic operation seed storage part 106_3.
The fourth share reconstruction data generation part 102_4 acquires seed₃ from the fourth basic operation seed storage part 106_4.
The fourth share reconstruction data generation part 102_4 acquires [x]₄=(x₁⊕x₂, x₂⊕₃) from the fourth data storage part 107_4.

Here, the second share reconstruction data generation part 102_2, the third share reconstruction data generation part 102_3, and the fourth share reconstruction data generation part 102_4 compute r′=h(sid,seed₃).

The second share reconstruction data generation part 1022, the third share reconstruction data generation part 102_3, and the fourth share reconstruction data generation part 102_4, respectively, transmit r′ as described above, to the second data storage part 1072, the third data storage part 107_3, and the fourth data storage part 107_4.

The fourth share reconstruction data generation part 1024, by using [x]₄=(x₁⊕x₂,x₂⊕x₃), generates

z=((x₁⊕₂)⊕(x₂⊕x₃))+r′=(x₁⊕x₃)+r′

and transmits z to the first share construction part 103_1 and the fourth share construction part 103_4.
In the same way, the third share reconstruction data generation part 102_3 generates

z=z′=(x₁⊕x₃)+r′

and transmits z to the third share construction part 103_3, and z′ to the third data storage part 107_3.

Where

sid∈{0,1}*

where sid is, for example, a counter and commonly shared among each server apparatus 100_1 to 100_4.

### (Step A3)

Each share construction part 103_1, 103_2, 103_3, and 103_4 takes out, respectively, from each data storage part 107_1, 107_2, 107_3, and 107_4, [x]₁, [x]₂, [x]₃, and [x]₄.

Each share construction part 103_1, 1032, 103_3, and 103_4 constructs a share using values transmitted at step A2 as described above, by the following eight expressions (equations).

[x₂]₁ⁿ=(r,x₂−2r)

[x₂]₂ⁿ=(x₂−2r,r)

[x₂]₃ⁿ=(r,r)

[x₂]₄ⁿ=(−x₂+3r,x₂−3r)

[x₁⊕x₃]₁ⁿ=(z,0)

[x₁⊕x₃]₂ⁿ=(0,−r′)

[x₁⊕x₃]₃ⁿ=(−r′,z)

[x₁⊕x₃]₄ⁿ=(z,r′)

[x₁⊕x₃]ᵢⁿ and [x₂]ᵢⁿ are stored in each i-th data storage part 107_i.

In this way, each share construction part 103_i, using a value [x] retained in each server apparatus 100_i and data (e.g., random numbers r, r′, z etc.) generated by a share reconstruction data generation part 102_i, from a share [x] of a value x on [symbol] ₂, reconstructs shares [x₂]ⁿ of a value x₂ and shares [x₁⊕x₃]ⁿ of x₁⊕x₃, on [symbol] ₂_{ⁿ}.

More specifically, top to the fourth expressions out of the eight expressions described above show reconstructed shares concerning x₂. The fifth to eighth expressions from the top out of the eight expressions described above represent reconstructed shares concerning x₁⊕x₃.

Checking the top to the fourth expressions in the eight expressions described above, as for a value x₂, where x₂=x₂_1+x₂_2+x₂_3 holds, then the followings hold.

x₂_1=r,

x₂_2=x₂−2r, and

x₂_3=r.

It can be understood that a random number r, which is created when data for reconstructing a share of a value x is generated by an i-th share reconstruction data generation part 102_i, is correctly generated. That is, the i-th share reconstruction data generation part 102_i generates a random number, when generating data for reconstructing a share of a value x, such that two values in x₁, x₂, and x₃ become equal, where x=x₁+x₂+x₃.

From the fifth to eighth expressions from the top in the eight expressions described above,

when x₁⊕x₃=x′=x1′+x2′+x3′

the followings hold.

x′₁=x₁⊕x₃+r′,

x′₂=0,

x′₃=−r′.

It can be understood that a random number r, which is created by the i-th share reconstruction data generation part 102_i when data for reconstructing shares of a value x₁⊕x₃ is created, is correctly generated. That is, the i-th share reconstruction data generation part 102_i generates a random number r, when generating data for reconstructing a share of a value x′, such that letting r be a random number, x₁′=x′+r, x₂′=0, and x₃′=−r hold, where x′=x1′+x2′+x3′.

### (Step A4)

Each i-th arithmetic operation part 105_i computes exclusive OR processing on a ring XOR_on_Ring as follows by communicating with each other.

XOR_on_Ring is processing in which
[a₁]ⁿ and [a₂]ⁿ(a₁,a₂∈ [symbol] ₂) are inputted and
[a₁⊕a₂]ⁿ is outputted.
For example, following expression hold.

[x₁⊕x₂⊕x₃]ⁿ←XOR_on_Ring([x₁⊕x₃]ⁿ,[x₂]ⁿ)

where x₁⊕x₂⊕x₃=x holds.
Each i-th arithmetic operation part 105_i stores [x]ⁿ in each data storage part 107_i. In this way, an arithmetic operation part 105_i computes an exclusive OR on a ring using share for bit embedding.

### (Step A5)

The first share reconstruction data generation part 102_1 takes out x₂ and r from the first data storage part 107_1. Next, the first share reconstruction data generation part 102_1 transmits x₂−3r to a fourth fraud detection part 104_4.

The fourth fraud detection part 104_4 takes out

[x₂]₄ⁿ=((x₂)_{4,1},(x₂)_{4,2})

stored in a fourth data storage part 107_4 and verifies whether

(x₂)_{4,1}=−(x₂−3r) and

(x₂)_{4,2}=x₂−3r

hold.

If the above condition holds, the fourth fraud detection part 104_4 broadcasts a character string of “success” to each server apparatus 100_1, 100_2, 100_3, and 100_4 to proceed to a next step. If the above condition does not hold, the fourth fraud detection part 104_4 broadcasts a character string of “abort” to each server apparatus 100_1, 100_2, 100_3, and 100_4 to abort a protocol concerning the secure computation.

A third fraud detection part 104_3 takes out z′ from a third data storage part 107_3 and transmits z′ to the first fraud detection part 104_1.

The first fraud detection part 104_1 takes out z from the first data storage part 107_1 and verifies whether or not z=z′ holds.

If z=z′ holds, the first fraud detection part 104_1 broadcasts a character string of “success” to each server apparatus 100_2, 100_3, and 100_4 to proceed to a next step.

If z=z′ does not hold, the first fraud detection part 104_1 broadcasts a character string of “abort” to each server apparatus 100_2, 100_3, and 100_4 to abort a protocol.

As for x₂−3r and z′, a hash value for one acquired by concatenating respective values is transmitted and verification may be performed by comparing hash values with each other, when performing a large amount of bit embedding processing in parallel. In this case, it can be considered that transmission volume of hash values can be negligible with respect to entire computation amount of the processing.

### (Step A6)

Each i-th fraud detection part 104_i performs fraud detection by using and comparing transmission and reception data in XOR_on_Ring in step A4 as described above. The first to fourth server apparatuses 100_1, 100_2, 100_3, and 100_4 on which fraud has not been detected broadcast a character string of “success” to each server apparatus. The first to fourth server apparatuses 100_1, 100_2, 100_3, and 100_4 on which fraud has been detected broadcast a character string of “abort” to each server apparatus to abort a protocol concerning the secure computation. This is implemented by four-party secure computation which enables fraud-detection fraud as described above. Step A6 can be executed in parallel with step A5 as described above.

In this way, the fraud detection part 104_i detects presence or absence of a wrongdoer using data transmitted and received at the time of computing shares for bit embedding or an exclusive OR.

As described above, in the first example embodiment, effects as described below will be obtained.

A first effect is that it is possible to perform bit embedding of a share using the four-party secure computation which enables fraud-detection. In a case where steps related fraud-detection are performed in parallel upon performing a complicated mixed circuit, it is regarded as communication cost concerning the fraud detection can be canceled. In this case, the communication cost becomes 7n bits·two rounds. On the other hand, communication cost of bit embedding in a case where NPL 2 and NPL 3 are combined is 42n bits·two rounds, when assuming that a probability for success of fraud is 2⁻⁴⁰. Therefore, the scheme described in the present disclosure is a more efficient scheme (communication cost is reduced).

A second effect is that the probability of fraud detection always becomes “1” when performing bit embedding of shares using the four-party secure computation which enables to detect fraud. In a case where NPL 2 and NPL 3 are combined, because a probability of fraud detection is parameterized, if the probability of fraud detection is to be improved, communication cost also increases. There are various applications to which secure computation can be applied and a probability of fraud detection required different, depending on the application. It is a burden for a user to investigate a required requirement and accompanying setting of each parameter based on the investigation. In the present disclosure, because the probability of fraud detection is “1”, burden to investigate requirements and setting parameters are alleviated.

### Second Example Embodiment

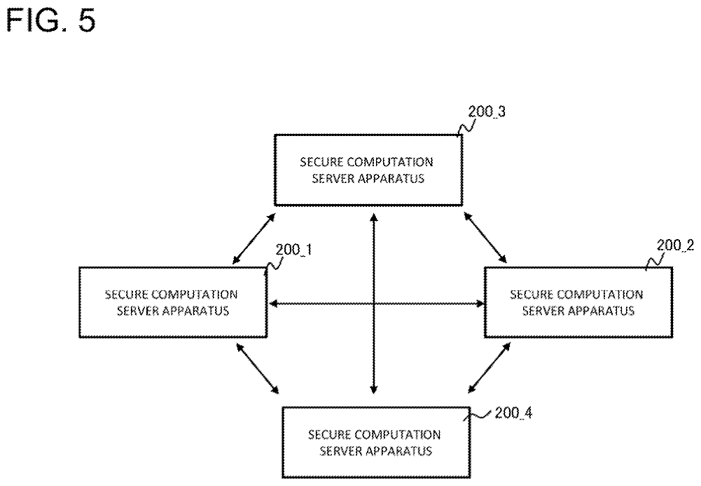

Bit embedding processing system according to a second example embodiment will be described in detail with reference to FIG. 5 to FIG. 7.

FIG. 5 is a block diagram illustrating an example of a functional configuration of bit embedding processing system according to a second example embodiment. The bit embedding processing system according to the second example embodiment is an example of a variation of the bit embedding processing system according to the first example embodiment as described above. In the second example embodiment below, the same reference signs are assigned to parts having the same functions as those of the parts previously described in the first example embodiment and the description thereof will be omitted.

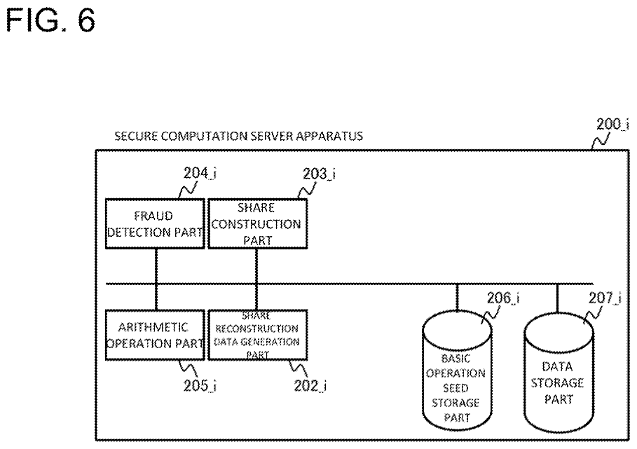

Referring to FIG. 5, the bit embedding processing system according to the first example embodiment includes i-th (i=1, 2, 3, and 4) server apparatuses which are later described with reference to FIG. 6. In the bit embedding processing system according to the second example embodiment, server apparatuses 200_1, 200_2, 200_3, and 200_4 are communicably connected to server apparatuses different from themselves via a network. FIG. 6 is a block diagram illustrating an example of a functional configuration of the i-th server apparatus 200_i (i=1, 2, 3, and 4) according to the second example embodiment.

As illustrated in FIG. 6, the i-th server apparatus 200_i includes an i-th share reconstruction data generation part 202_i, an i-th share construction part 203_i, an i-th fraud detection part 204_i, an i-th arithmetic operation part 205_i, an i-th basic operation seed storage part 206_i, and an i-th data storage part 207_i. The i-th share reconstruction data generation part 202_i, the i-th share construction part 203_i, the i-th fraud detection part 204_i, the i-th arithmetic operation part 205_i, the i-th basic operation seed storage part 206_i, and the i-th data storage part 207_i are respectively connected.

In the bit embedding processing system having the abode described configurations,

for a value x∈ [symbol] ₂, which any of the first to fourth server apparatuses 200_1 to 200_4 has inputted,
a share [x], which is stored in the first to fourth data storage part 207_1 to 207_4 or,
a share [x] which has been inputted from outside that is not the first to fourth server apparatuses 200_1 to 200_4,
[x]ⁿ is computed without a value x being known from the input or a value under a computation process and is stored in the first to fourth data storage part 207_1 to 207_4. Shares of the above computation result may be transmitted and received by the first to fourth server apparatuses 200_1 to 200_4 and restored. Alternatively, shares may be transmitted to outside thereof that is not the first to fourth server apparatuses 200_1 to 200_4 and restored.

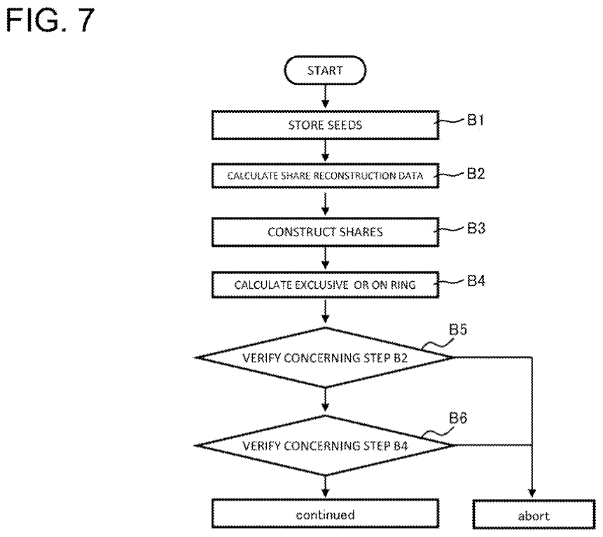

Next, an operation of the bit embedding processing system and the first to fourth server apparatuses 200_1 to 200_4 according to the second example embodiment will be described in detail. FIG. 7 is a flowchart illustrating an example of an operation concerning bit embedding of the first to fourth server apparatuses 200_1 to 200_4.

### (Step B1)

Each basic operation seed storage part 206_1 to 2064 respectively stores

(seed₁,seed₂,seed₄,seed′₁,seed′₂),
(seed₂,seed₃,seed₄,seed′₂,seed′₃),
(seed₃,seed₁,seed₄,seed′₃,seed′₁), and
(seed₁,seed₂,seed₃).

Each server apparatus 200_1 to 200_4 commonly shares a pseudo-random function h. The followings are assumed.

seedᵢ,seed′₁,seed′₂,seed′₃∈{0,1}*(i=1,2,3,4)

The pseudo-random function is given as:

h:{0,1}*×{0,1}*→{0,1}ⁿ

Each data storage part 207_1 to 207_4 respectively stores

[x]₁=(x₁,x₂),[x]₂=(x₂,x₃),[x]₃=(x₃,x₁),[x]₄=(x₁⊕x₂,x₂⊕x₃),

where [x]ᵢ(i=1, 2, 3, 4) is [x] stored in each data storage part 107_i.

It is intended to create a situation in which, with respect to seedᵢ, in the server apparatuses 200_i (i=1, 2, 3, 4), one participant cannot compute an output of h and other three participants can compute an output of h. It is intended to create a situation in which, with respect to seed′₁, seed′₂ and seed′₃ in the server apparatuses 200_1, 200_2, and 200_3, one participant cannot compute an output of h and other two participants can compute an output of h. As far as this situation can be created, handling of seedᵢ,seed′₁,seed′₂,and seed′₃ is not particularly limited. In the present description, seedᵢ,seed′₁,seed′₂, and seed′₃ is just an example.

### (Step B2)

The first share reconstruction data generation part 202_1 and the second share reconstruction data generation part 202_2 respectively acquire seed′₂ from the first basic operation seed storage part 206_1 and the second basic operation seed storage part 206_2.

Next, the first share reconstruction data generation part 202_1 and the second share reconstruction data generation part 202_2 generate r₂=h(sid,seed′₂), r′₂=h(sid,seed′₂), x′=x₂−r₂−r′₂. Then, the first share reconstruction data generation part 202_1 stores x′₂,r₂,r′₂ in the first data storage part 207_1. The second share reconstruction data generation part 202_2 transmits r₂, and r′₂ to the third share construction part 203_3. The second share reconstruction data generation part 202_2 transmits r₂−x′₂ and x′₂−r′₂ to the fourth share construction part 203_4.

In the same way, the second share reconstruction data generation part 202_2 and the third share reconstruction data generation part 202_3 generate

r₃=h(sid,seed′₃),r′₃=h(sid,seed′₃),x′₃=x₃−r₃−r′₃.

The second share reconstruction data generation part 202_2 stores x′₃,r₃, and r′₃ in the second data storage part 207_2.
The third share reconstruction data generation part 202_3 transmits r₃ and r′₃ to the first share construction part 203_1.
The third share reconstruction data generation part 202_3 transmits r₃−r′₃ and r′₃−x′₃ to the fourth share construction part 203_4.

In the same way, the third share reconstruction data generation part 202_3 and the first share reconstruction data generation part 202_1 generate

r₁=h(sid,seed′₁),r′₁=h(sid,seed′₁),x′₁=x₁−r₁−r′₁.

The third share reconstruction data generation part 202_3 stores x′₁,r₁, and r′₁ in the third data storage part 207_3.
The first share reconstruction data generation part 202_1 transmits r₁ and r′₁ to the second share construction part 203_2.
The first share reconstruction data generation part 202_1 transmits x′₁−r₁ and r₁−r′₁ to the fourth share construction part 203_4.

Where sid∈{0,1}*

sid is, for example, a counter and commonly shared among each server apparatus 200_1 to 200_4.

### (Step B3)

Each share construction part 203_1, 2032, 203_3, and 203_4 constructs a share using a value transmitted at step B2 as described above, using the following twelve expressions.

[x₂]₁ⁿ=(r₂,x′₂)

[x₂]₂ⁿ=(x′₂,r′₂)

[x₂]₃ⁿ=(r′₂,r₂)

[x₂]₄ⁿ=(r₂−x′₂,x′₂−r′₂)

[x₃]₁ⁿ=(r₃,r′₃)

[x₃]₂ⁿ=(r′₃,x′₃)

[x₃]₃ⁿ=(x′₃,r₃)

[x₃]₄ⁿ=(r₃−r′₃,r′₃−x′₃)

[x₁]₁ⁿ=(x′₁,r₁)

[x₁]₂ⁿ=(r₁,r′₁)

[x₁]₃ⁿ=(r′₁,x′₁)

[x₁]₄ⁿ=(x′₁−r₁,r₁−r′₁)

[x₁]ᵢⁿ, [x₂]ᵢⁿ and [x₃]ᵢⁿ are stored in each i-th data storage part 207_i.

### (Step B4)

Each i-th arithmetic operation part 205_i computes an exclusive OR processing on a ring XOR_on_Ring as follows by communicating with each other, where XOR_on_Ring is processing in which [a₁]ⁿ, and [a₂]ⁿ(a₁,a₂∈ [symbol] ₂) are inputted and [a₁⊕a₂]ⁿ is outputted. For example, following equations hold.

[x₁⊕x₂]ⁿ←XOR_on_Ring([x₁]ⁿ,[x₂]ⁿ),

[x₁⊕x₂⊕x₃]ⁿ←XOR_on_Ring([x₁⊕x₂]ⁿ,[x₃]ⁿ)

where x₁⊕x₂⊕x₃=x holds. Each i-th arithmetic operation part 205_i stores [x]ⁿ in each data storage part 207_i.

### (Step B5)

A first share reconstruction data generation part 202_1 takes out x′₂,r₂,and r′₂ from a first data storage part 207_1.

Next, the first share reconstruction data generation part 202_1 transmits r₂, and r′₂ to a third fraud detection part 204_3.
The first share reconstruction data generation part 202_1 transmits r₂−x′₂, and x′₂−r′₂ to a fourth fraud detection part 204_4.

The third fraud detection part 204_3 and the fourth fraud detection part 204_4 respectively take out [x₂]₃ⁿ stored in the third data storage part 207_3 and [x₂]₄ⁿ stored in the fourth data storage part 207_4 and verify whether or not the values match.

If the values match, the third fraud detection part 204_3 or the fourth fraud detection part 204_4 broadcasts a character string of “success” to each server apparatus 200_1, 200_2, 200_3, and 200_4 to proceed to a next step. If they do not match, the third fraud detection part 204_3 or the fourth fraud detection part 204_4 broadcasts a character string of “abort” to each server apparatus 200_1, 200_2, 200_3, and 200_4 to abort a protocol concerning the secure computation.

When performing a large amount of bit embedding processing in parallel, for the above verification, it may be possible to verify whether or not a hash value for a value acquired by concatenating respective values r₂, and r′₂ and a hash value for a value acquired by concatenating respective values related to [x₂]₃ⁿ are matched. In this case, it can be considered that the hash value for the value acquired by concatenating the respective values r₂ and r′₂ may be negligible with respect to communication traffic (volume) of entire processing. The same applies to r₂−x′₂, x′₂−r′₂, and [x₂]₄ⁿ.

Similarly, a second share reconstruction data generation part 202_2 takes out x′₃,r₃ and r′ from a second data storage part 207_2. Next, the second share reconstruction data generation part 202_2 transmits r₃ and r′₃ to the first fraud detection part 204_1. The second share reconstruction data generation part 202_2 transmits r₃−r′₃, and r′₃−x′₃ to a fourth fraud detection part 204_4.

The first fraud detection part 204_1 and the fourth fraud detection part 204_4 respectively take out [x₃]₁ⁿ stored in the first data storage part 207_1 and [x₃]₄ⁿ stored in the fourth data storage part 207_4 and verify whether or not the values match.

If the values match, the first fraud detection part 204_1 or the fourth fraud detection part 204_4 broadcasts a character string of “success” to each server apparatus 200_1, 200_2, 200_3, and 200_4 to proceed to a next step. If the values do not match, the first fraud detection part 204_1 or the fourth fraud detection part 204_4 broadcasts a character string of “abort” to each server apparatus 200_1, 200_2, 200_3, and 200_4 to abort a protocol concerning the secure computation.

When performing a large amount of bit embedding processing in parallel, for the above verification, it may be possible to verify whether or not a hash value for a value acquired by concatenating respective values r₃ and r′₃ and a hash value for a value acquired by concatenating respective values related to [x₃]₁ⁿ match. In this case, it can be considered that the hash value for the value acquired by concatenating respective values r₃ and r′₃ may be negligible with respect to communication traffic of entire processing. The same applies to r₃−r′₃, r′₃−x′₃, and [x₃]₄ⁿ.

In the same way, a third share reconstruction data generation part 202_3 takes out x′₁,r₁,r′₁ from a third data storage part 207_3. Next, the third share reconstruction data generation part 202_3 transmits r₁ and r′₁ to the second fraud detection part 204_2. The third share reconstruction data generation part 202_3 transmits x′₁−r₁ and r₁−r′₁ to the fourth fraud detection part 204_4.

The second fraud detection part 204_2 and the fourth fraud detection part 204_4 respectively take out [x₁]₂ⁿ stored in the second data storage part 207_2 and [x₁]₄ⁿ stored in a fourth data storage part 207_4 and verify whether or not the values match.

If the values match, the second fraud detection part 204_2 or the fourth fraud detection part 204_4 broadcasts a character string of “success” to each server apparatus 200_1, 200_2, 200_3, and 200_4 to proceed to a next step. If the values do not match, the second fraud detection part 204_2 or the fourth fraud detection part 204_4 broadcasts a character string of “abort” to each server apparatus 200_1, 200_2, 200_3, and 200_4 to abort a protocol concerning the secure computation.

Please note that when performing a large amount of bit embedding processing in parallel, for the above verification, it may be possible to verify whether or not a hash value for a value acquired by concatenating respective values r₁ and r′₁ and a hash value for a value acquired by concatenating respective values related to [x₁]₂ⁿ match. In this case, it can be considered that the hash value for the value acquired by concatenating respective values r₃ and r′₃ may be negligible with respect to communication traffic (volume) of entire processing. The same applies to x′₁−r₁, r₁−r′₁ and [x₁]₄ⁿ.

### (Step B6)

Each i-th fraud detection part 204_i performs the fraud detection by using transmission and reception data in XOR_on_Ring in step B4 as described above and comparing them. The first to fourth server apparatuses 200_1, 200_2, 200_3, and 200_4 on which fraud has not been detected broadcast a character string of “success” to each server apparatus. The first to fourth server apparatuses 200_1, 200_2, 200_3, and 200_4 on which fraud has been detected broadcast a character string of “abort” to each server apparatus to abort a protocol concerning the secure computation. This is realized by four-party secure computation which enables to detect fraud as described above. Step B6 can be executed in parallel with step B5 as described above.

In the second example embodiment as described above, the same effects as those in the first example embodiment can be obtained. However, with respect to the first effect of the first example embodiment, it is to be noted that, in the second example embodiment, the number of computations of XOR_on_Ring which corresponds to the exclusive OR computation on a ring is increased. In the first example embodiment, with respect to the bit embedding, it can be performed by computing XOR_on_Ring once. On the other hand, in the second example embodiment, with respect to the bit embedding, it can be performed by computing XOR_on_Ring twice. The communication cost is 16n bits·3 rounds.

As described above, although, with respect to theoretical communication cost, the second example embodiment is inferior to the first example embodiment, it should be noted that a communication mode has changed. For example, in step A2 of FIG. 4 in the first example embodiment, communication from the fourth server apparatus 200_4 to the first server apparatus 200_1 occurs. On the other hand, in the second example embodiment, when performing bit embedding, communication from the fourth server apparatus 200_4 to the first server apparatus 200_1 does not occur. Since the mode of commincation changes in this way, there is a case where the second embodiment may be more efficient according to certain communication environment.

### Third Example Embodiment

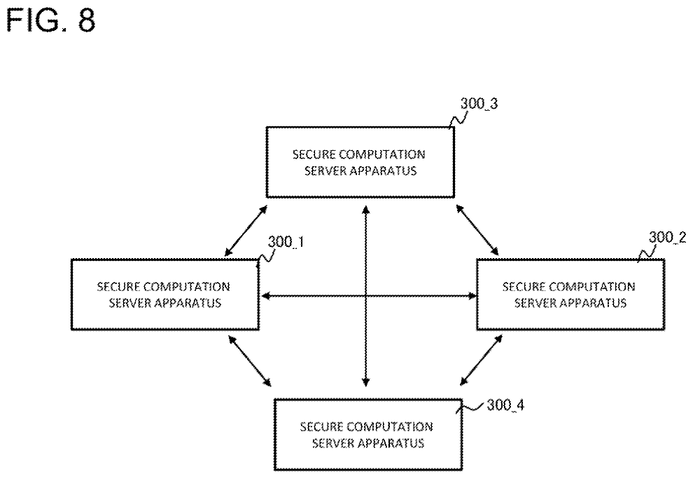

Bit embedding processing system according to a third example embodiment will be described with reference to FIG. 8 to FIG. 10.

FIG. 8 is a block diagram illustrating an example of a functional configuration of bit embedding processing system according to the third example embodiment. The bit embedding processing system according to the third example embodiment is an example of a variation of the bit embedding processing system according to the first example embodiment and the second example embodiment as described above. In the third example embodiment below, the same reference signs are assigned to parts having the same functions as those of the parts previously described in the first example embodiment and the second example embodiment, and the description thereof will be omitted.

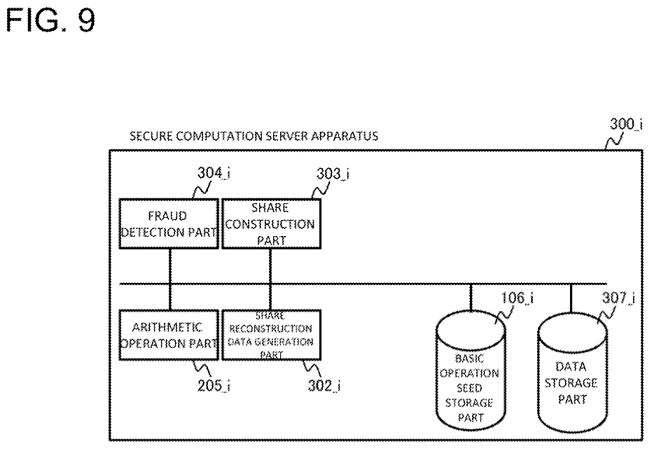

Referring to FIG. 8, the bit embedding processing system according to the third example embodiment includes i-th (i=1, 2, 3, and 4) server apparatuses which is later described with reference to in FIG. 9. In the bit embedding processing system according to the third example embodiment, server apparatuses 300_1, 300_2, 300_3, and 300_4 are communicably connected to server apparatuses different from themselves via a network. FIG. 9 is a block diagram illustrating an example of a functional configuration of the i-th server apparatus 300_i (i=1, 2, 3, and 4).

As illustrated in FIG. 9, the i-th server apparatus 300_i includes an i-th share reconstruction data generation part 302_i, an i-th share construction part 303_i, an i-th fraud detection part 304_i, an i-th arithmetic operation part 205_i, an i-th basic operation seed storage part 106_i, and an i-th data storage part 307_1. Please note that the i-th share reconstruction data generation part 302_i, the i-th share construction part 303_i, the i-th fraud detection part 304_i, the i-th arithmetic operation part 205_i, the i-th basic operation seed storage part 106_i, and the i-th data storage part 307_1 are respectively connected.

In the bit embedding processing system having the above described configuration, for

a value x∈ [symbol] ₂, which any of the first to fourth server apparatuses 300_1 to 300_4 has inputted,
a share [x], stored in the first to fourth data storage part 307_1 to 307_4, or
a share [x] which has been inputted from outside thereof that is not the first to fourth server apparatuses 300_1 to 300_4,
[x]ⁿ is computed and stored in the first to fourth data storage part 307_1 to 307_4, without a value x being known from the input or a value under a computation process. Shares of the above computation result may be transmitted and received by the first to fourth server apparatuses 300_1 to 300_4 and restored. Alternatively, shares may be transmitted to outside thereof that is not the first to fourth server apparatuses 300_1 to 300_4 and restored.

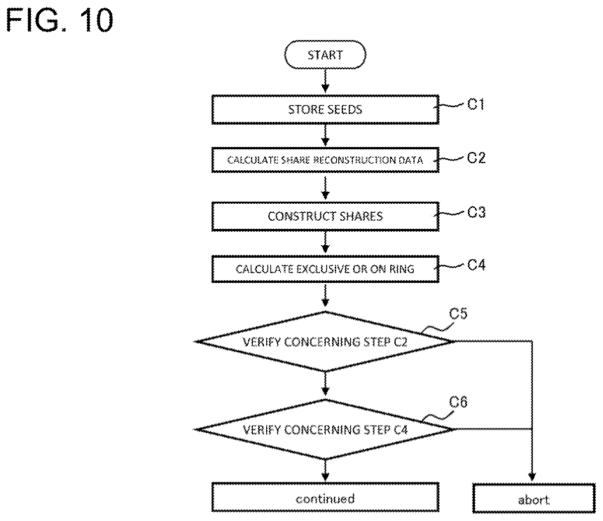

Next, an operation of the bit embedding processing system and the first to fourth server apparatuses 300_1 to 300_4 in the third example embodiment will be described in detail. FIG. 10 is a flowchart illustrating an example of an operation concerning bit embedding of the first to fourth server apparatuses 300_1 to 300_4.

### (Step C1)

Each basic operation seed storage part 106_1, 1062, 1063, and 106_4 respectively stores

(seed₁,seed₂,seed₄),
(seed₂,seed₃,seed₄),
(seed₃,seed₁,seed₄), and
(seed₁,seed₂,seed₃).

Each server apparatus 300_1 to 300_4 commonly shares a pseudo-random function h.

Where

seedᵢ∈{0,1}*(i=1,2,3,4)

The pseudo-random function is given as:

h:{0,1}*×{0,1}*→{0,1}

Each data storage part 307_1 to 307_4 respectively stores

[x]₁=(x₁,x₂),[x]₂=(x₂,x₃),[x]₃=(x₃,x₁), and [x]₄=(x₁⊕x₂,x₂⊕x₃)

where [x]ᵢ(i=1, 2, 3, 4) is [x] stored in each data storage part 307_i.

It is intended to create a situation in which with respect to seedᵢ in the server apparatuses 300_i (i=1, 2, 3, 4), one participant cannot compute an output of h and other three participants can compute an output of h. As far as this situation can be created, handling of seedᵢ is not particularly limited. In the present description, seedᵢ is just an example.

### (Step C2)

The first share reconstruction data generation part 302_1, the second share reconstruction data generation part 3022, and the third share reconstruction data generation part 302_3 respectively acquire seed₄ from the first basic operation seed storage part 106_1, the second basic operation seed storage part 1062, and the third basic operation seed storage part 106_3.

Next, the first share reconstruction data generation part 302_1, the second share reconstruction data generation part 3022, and the third share reconstruction data generation part 302_3 generate

r₂=h(sid∥2,seed₄).

Then, the first share reconstruction data generation part 302_1 transmits r₂ to the first share construction part 303_1. The third share reconstruction data generation part 302_2 transmits r₂ to the third share construction part 303_4.

The second share reconstruction data generation part 302_2 takes out x₂ from the second data storage part 307_2 and transmits x₂−3r₂ to the fourth share construction part 303_4.

In the same way, the first share reconstruction data generation part 302_1, the second share reconstruction data generation part 302_2, and the third share reconstruction data generation part 302_3 generate

r₃=h(sid∥3,seed₄).

The second share reconstruction data generation part 302_2 transmits r₃ to the second share construction part 303_2.
The first share reconstruction data generation part 302_1 transmits r₃ to the first share construction part 303_1.

The third share reconstruction data generation part 302_3 takes out x₃ from the third data storage part 307_3 and transmits x₃−3r₃ to the fourth share construction part 303_4.

In the same way, the first share reconstruction data generation part 302_1, the second share reconstruction data generation part 302_2, and the third share reconstruction data generation part 302_3 generate

r₁=h(sid∥1,seed′₁).

The third share reconstruction data generation part 302_3 transmits r₁ to the third share construction part 303_3. The second share reconstruction data generation part 302_2 transmits r₁ to the second share construction part 303_2.

The first share reconstruction data generation part 302_1 takes out x₁ from the first data storage part 307_1 and transmits x₁−3r₁ to the fourth share construction part 303_4.

where,

sid∈{0,1}*

sid is, for example, a counter and commonly shared among each server apparatus 300_1 to 300_4.

### (Step C3)

Each share construction part 304_1, 304_2, 304_3, and 304_4 construct shares using values transmitted at step C2 as described above and [x]ᵢ stored in each i-th data storage part 307_i, by the following twelve expressions.

[x₂]₁ⁿ=(r₂,x₂−2r₂)

[x₂]₂ⁿ=(x₂−2r₂,r₂)

[x₂]₃ⁿ=(r₂,r₂)

[x₂]₄ⁿ=(r₂−(x₂−2r₂),(x₂−2r₂)−r₂)

[x₃]₁ⁿ=(r₃,r₃)

[x₃]₂ⁿ=(r₃,x₃−2r₃)

[x₃]₃ⁿ=(x₃−2r₃,r₃)

[x₃]₄ⁿ=(0,r₃−(x₃−2r₃))

[x₁]₁ⁿ=(x₁−2r₁,r₁)

[x₁]₂ⁿ=(r₁,r₁)

[x₁]₃ⁿ=(r₁,x₁−2r₁)

[x₁]₄ⁿ=((x₁−2r₁)−r₁,0)

[x₁]ᵢⁿ, [x₂]ᵢⁿ, and [x₃]ᵢⁿ are stored in each i-th data storage part 307_i.

In this way, each share reconstruction data generation part 302_i generates a random number used for reconstruction of shares. At that time, each share reconstruction data generation part 302_i generates the random number, when generating share reconstruction data concerning a value x′, such that two values in x′₁, x′₂, and x′₃ become equal where x′=x′₁+x′₂+x′₃.

In the example of the step C3 above, for example, if x′=x₂ then, a random number is generated such that x′₁=x′₃=r₂ holds.

### (Step C4)

Each i-th arithmetic operation part 205_i computes an exclusive OR processing on a ring XOR_on_Ring as follows by communicating with each other. XOR_on_Ring is processing in which [a₁]ⁿ and [a₂]ⁿ(a₁,a₂ ∈ [symbol] ₂) are inputted and [a₁⊕a₂]ⁿ is outputted. For example, following equations hold.

[x₁⊕x₂]ⁿ←XOR_on_Ring([x₁]ⁿ,[x₂]ⁿ)

[x₁⊕x₂⊕x₃]ⁿ←XOR_on_Ring([x₁⊕x₂]ⁿ,[x₃]ⁿ)

where,

x₁⊕x₂⊕x₃=x

Each i-th arithmetic operation part 205_1 stores [x]n in each data storage part 307_i.

### (Step C5)

A first share reconstruction data generation part 302_1 takes out r₂,and x₂ from a first data storage part 307_1. Next, the first share reconstruction data generation part 302_1 transmits x₂−3r₂ to a fourth fraud detection part 304_4.

The fourth fraud detection part 304_4 takes out [x₂]₄ⁿ=(x_{2,1},x_{2,2}) stored in a fourth data storage part 307_4 and verifies whether or not x_{2,1}=−(x₂−3r₂) and x_{2,2}=x₂−3r₂ hold.

If the above relations hold, the fourth fraud detection part 304_4 broadcasts a character string of “success” to each server apparatus 300_1, 300_2, 300_3, and 300_4 to proceed to a next step. If the above relations do not hold, the fourth fraud detection part 304_4 broadcasts a character string of “abort” to each server apparatus 300_1, 300_2, 300_3, and 300_4 to abort a protocol concerning the secure computation.

Similarly, a second share reconstruction data generation part 302_2 takes out r₃ and x₃ from a second data storage part 307_2. Next, the second share reconstruction data generation part 302_2 transmits x₃−3r₃ to the fourth fraud detection part 304_4. The fourth fraud detection part 304_4 takes out [x₃]₄ⁿ=(0,x_{3,2}) stored in the fourth data storage part 307_4 and verifies whether or not x_{3,2}=−(x₃−3r₃) holds.

If the above equation holds, the fourth fraud detection part 304_4 broadcasts a character string of “success” to each server apparatus 300_1, 300_2, 300_3, and 300_4 to proceed a next step.

If the above equation does not hold, the fourth fraud detection part 304_4 broadcasts a character string of “abort” to each server apparatus 300_1, 300_2, 300_3, and 300_4 to abort a protocol concerning the secure computation.

In the same way, a third share reconstruction data generation part 302_3 takes out r₁ and x₁ from a third data storage part 307_3. Next, the third share reconstruction data generation part 302_3 transmits x₁−3r₁ to the fourth fraud detection part 304_4.

The fourth fraud detection part 304_4 takes out [x₁]₄ⁿ=(x_{1,1},0) stored in the fourth data storage part 307_4 and verifies whether or not x_{1,1}=x₁−3r₁ holds.

If the above relation holds, the fourth fraud detection part 304_4 broadcasts a character string of “success” to each server apparatus 300_1, 300_2, 300_3, and 300_4 to proceed to a next step. If it does not hold, the fourth fraud detection part 304_4 broadcasts a character string of “abort” to each server apparatus 300_1, 300_2, 300_3, and 300_4 to abort a protocol.

When performing a large amount of bit embedding processing in parallel, it may be possible to verify by transmitting hash values for one acquired by concatenating respective values with respect to xᵢ−3rᵢ (i=1, 2, 3) and comparing hash values each other. In this case, it can be considered that transmission amount of the hash values may be negligible with respect to computation amount of entire processing.

### (Step C6)

Each i-th fraud detection part 304_i performs the fraud detection by using data transmitted and received in XOR_on_Ring in step C4 as described above and comparing them. The first to fourth server apparatuses 300_1, 300_2, 300_3, and 300_4 on which fraud has not been detected broadcast a character string of “success” to each server apparatus. The first to fourth server apparatuses 300_1, 300_2, 300_3, and 300_4 on which fraud has been detected broadcast a character string of “abort” to each server apparatus to abort a protocol. This is realized by four-party secure computation which enables to detect fraud as described above. Step C6 can be executed in parallel with step C5 as described above. That is, detecting presence or absence of a fraud doer by using the share for the bit embedding and detecting presence or absence of the fraud doer, by using data transmitted and received when computing the exclusive OR can be performed in parallel.

In the third example embodiment as described above, the same effects as those in the first example embodiment and the second example embodiment can be obtained. However, with respect to the first effect of the second example embodiment, it is to be noted that the third example embodiment is more efficient in terms of the communication cost. In the third example embodiment, in the same way as the second example embodiment, it can be performed by computing XOR_on_Ring corresponding to an exclusive OR on a ring, twice. A difference between the third example embodiment and the second example embodiment resides in that redispersion (resharing) before an exclusive OR computation on a ring is efficiently performed. When processing concerning the fraud detection are performed in parallel, in the third example embodiment, 13n bits·3 rounds is required as a communication cost of bit embedding. Accordingly, the third example embodiment is more efficient in terms of the communication cost than that of the first or second example embodiment.

### Fourth Example Embodiment

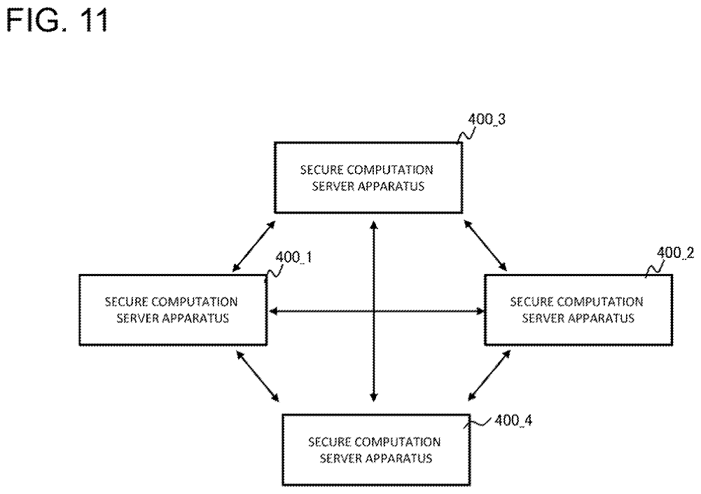

Bit embedding processing system according to a fourth example embodiment will be described Referring to FIG. 11 to FIG. 13.

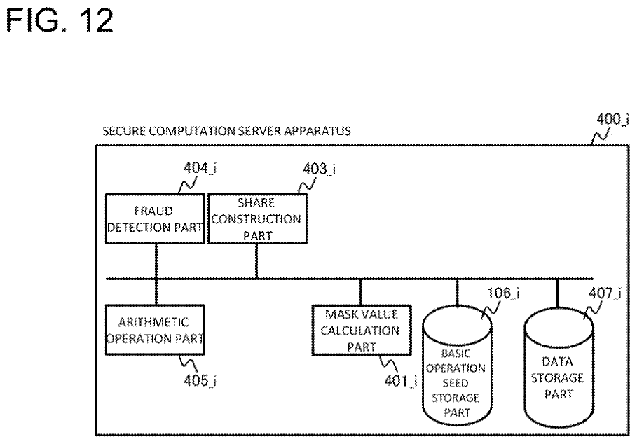

FIG. 11 is a block diagram illustrating an example of a functional configuration of a bit embedding system according to the fourth example embodiment. Referring to FIG. 11, the bit embedding processing system according to the fourth example embodiment includes i-th (i=1, 2, 3, and 4) server apparatuses referred to in FIG. 12 described later. In the bit embedding processing system according to the fourth example embodiment, server apparatuses 400_1, 400_2, 400_3, and 400_4 are communicably connected to server apparatuses different from themselves via a network. FIG. 12 is a block diagram illustrating an example of a functional configuration of the i-th server apparatus 400_i (i=1, 2, 3, and 4).

As illustrated in FIG. 12, the i-th server apparatus 400_i includes an i-th mask value computation part 401_i, an i-th share construction part 403_i, an i-th fraud detection part 404_i, an i-th arithmetic operation part 405_i, an i-th basic operation seed storage part 106_i, and an i-th data storage part 407_i. Please note that the i-th mask value computation part 401_i, the i-th share construction part 403_i, the i-th fraud detection part 404_i, the i-th arithmetic operation part 405_i, the i-th basic operation seed storage part 106_i, and the i-th data storage part 407_i are respectively connected.

In the bit embedding processing system having the configuration like this, for a value x∈ [symbol] ₂, which any of the first to fourth server apparatuses 400_1 to 400_4 has inputted,

or a share [x], stored in the first to fourth data storage part 407_1 to 4074, or

a share [x] which has been inputted from outside thereof that is not the first to fourth server apparatuses 400_1 to 4004,

[x]ⁿ is computed, without a value x being known from the input or a value under a computation process and stored in the first to fourth data storage part 407_1 to 407_4. Shares of the above computation result may be transmitted and received by the first to fourth server apparatuses 400_1 to 400_4 and restored. Alternatively, shares may be transmitted to outside thereof that is not the first to fourth server apparatuses 400_1 to 400_4 and restored.

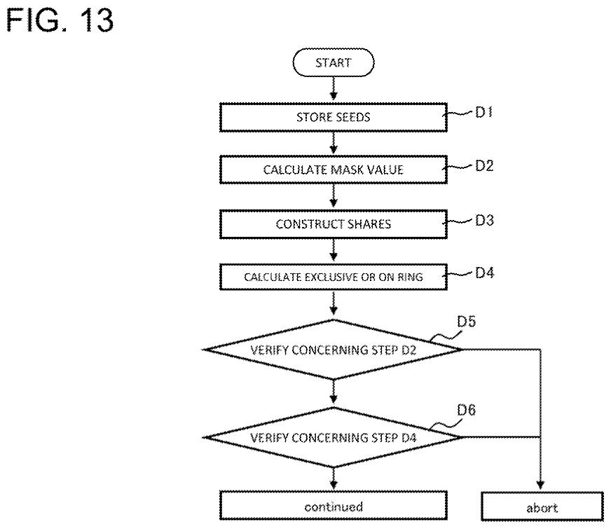

Next, an operation of the bit embedding processing system and the first to fourth server apparatuses 400_1 to 400_4 in the fourth example embodiment will be described in detail. FIG. 13 is a flowchart illustrating an example of an operation concerning bit embedding of the first to fourth server apparatuses 400_1 to 400_4.

### (Step D1)

Each basic operation seed storage part 106_1, 106_2, 106_3, and 106_4 respectively stores

(seed₁,seed₂,seed₄),
(seed₂,seed₃,seed₄),
(seed₃,seed₁,seed₄), and
(seed₁,seed₂,seed₃).

Each server apparatus 400_1 to 400_4 commonly shares a pseudo-random function h′.

### Where

seedᵢ∈{0,1}*(i=1,2,3,4)

The pseudo-random function is given as:

h′:{0,1}*×{0,1}*→{0,1}

Each data storage part 407_1 to 407_4 respectively stores

[x]₁=(x₁,x₂),[x]₂=(x₂,x₃),[x]₃=(x₃,x₁), and [x]₄=(x₁⊕x₂,x₂⊕x₃).

Where [x]₁(i=1, 2, 3, 4) is [x] stored in each data storage part 407_i. It is intended to create a situation in which with respect to seedᵢ, in the server apparatuses 400_i (i=1, 2, 3, 4), one participant cannot compute an output of h and other three participants can compute an output of h. As far as this situation can be created, handling of seedᵢ is not particularly limited. In the present description, seedᵢ is just an example.

### (Step D2)

A first, second, and third mask value computation part 401_1, 401_2, and 401_3 compute r=h(sidⱼ,seed′₁) and stores r in a first, second, and third data storage part 407_1, 407_2, and 407_3.

The second mask value computation part 401_2 takes out a share [x]₂=(x₂,x₃) from the data storage part 407_2.

The second mask value computation part 401_2 generates y=x₂⊕r and transmits y to the fourth server apparatus 400_4. The fourth server apparatus 400_4 stores y in the fourth data storage part 407_4.

sid∈{0,1}*

where sid is, for example, a counter and it is commonly shared among each server apparatus 400_1 to 400_4.

### (Step D3)

Each share construction part 403_1, 403_2, 403_3, and 403_4 respectively takes out

([x]₁,r),
([x]₂,r),
([x]₃,r), and
([x]₄,y) from each data storage part 407_1, 407_2, 407_3, and 407_4 and constructs shares by the following sixteen expressions:

[x₁⊕r]₁ⁿ=(x₁⊕r,0)

[x₁⊕r]₂ⁿ=(0,0)

[x₁⊕r]₃ⁿ=(0,x₁⊕r)

[x₁⊕r]₄ⁿ=(x₁⊕x₂⊕y,0)

[x₂⊕r]₁ⁿ=(0,x₂⊕r)

[x₂⊕r]₂ⁿ=(x₂⊕r,0)

[x₂⊕r]₃ⁿ=(0,0)

[x₂⊕r]₄ⁿ=(−y,y)

[x₃⊕r]₁ⁿ=(0,0)

[x₃⊕r]₂=(0,x₃⊕r)

[x₃⊕r]₃ⁿ=(x₃⊕r,0)

[x₃⊕r]₄ⁿ=(0,−(x₂⊕x₃⊕y))

[r]₁ⁿ=(3⁻¹·r,3⁻¹·r)

[r]₂ⁿ=(3⁻¹·r,3⁻¹·r)

[r]₃ⁿ=(3⁻¹·r,3⁻¹·r)

[r]₄ⁿ=(0,0)

[x₁⊕r]ⁿ, [x₂⊕r]ⁿ, [x₃⊕r]ⁿ, and [r]ⁿ are stored in each i-th data storage part 407_i. 3⁻¹ means a multiplicative inverse of 3 on [symbol] ₂_{ⁿ}. Since 3 and 2ⁿ are prime to each other for any n (≥2), 3⁻¹ exists on [symbol] ₂_{ⁿ}.

### (Step D4)

Each i-th arithmetic operation part 405_i computes an exclusive OR processing on a ring XOR_on_Ring as follows by communicating with each other. XOR_on_Ring is processing in which [a₁]ⁿ, [a₂]ⁿ(a₁,a₂ ∈ [symbol] ₂) are inputted and [a₁⊕a₂]ⁿ is outputted. For example, the followings hold.

[x₁⊕x₂]ⁿ←XOR_on_Ring([x₁⊕r]ⁿ,[x₂⊕r]ⁿ)

[x₃]ⁿ←XOR_on_Ring([x₃⊕r]ⁿ,[r]ⁿ)

[x₁⊕x₂⊕x]ⁿ←XOR_on_Ring([x₁⊕x₂]ⁿ,[x₃]ⁿ)

where,

x₁⊕x₂⊕x₃=x

Each i-th arithmetic operation part 405_i stores [x]ᵢⁿ in each data storage part 407_i.

### (Step D5)

In a first server apparatus 400_1, in the same way as the second server apparatus 400_2 in step D3 as described above, a first mask value computation part 401_1 generates y′=x₂⊕r and transmits y′ to a fourth server apparatus 400_4. The fourth server apparatus 400_4 stores y′ in a fourth data storage part 407_4.

A fourth fraud detection part 404_4 takes out y and y′ from the fourth data storage part 407_4 and verifies whether or not y=y′ holds.

If y=y′ holds, the fourth fraud detection part 404_4 broadcasts a character string of “success” to each server apparatus 400_1, 400_2, and 400_3 to proceed a next step.

If y=y′ does not hold, the fourth fraud detection part 404_4 broadcasts a character string of “abort” to each server apparatus 400_1, 400_2, and 400_3 to abort a protocol.

When performing a large amount of bit embedding in parallel, in each step D5, y′ are concatenated and a hash value σ′ is computed. As for y, a hash value σ is computed for the concatenated y. Verification whether or not y=y′ holds may be taken as verification whether or not σ=σ′ holds. In this case, communication volume about y′ may be negligible with respect to computation amount of entire processing.

### (Step D6)

Each i-th fraud detection part 404_i performs the fraud detection by using transmission and reception data in XOR_on_Ring in step D4 as described above and comparing the transmission and reception data. The first to fourth server apparatuses 400_1, 400_2, 400_3, and 400_4 on which fraud has not been detected broadcast a character string of “success” to each server apparatus. The first to fourth server apparatuses 400_1, 400_2, 400_3, and 400_4 on which fraud has been detected broadcast a character string of “abort” to each server apparatus to abort a protocol. This is realized by four-party secure computation which enables to detect fraud as described above. Step D6 can be executed in parallel with step D5 as described above.

In the fourth example embodiment as described, the same effects as those in the first to third example embodiments can be obtained. However, with respect to the first effect of the first to third example embodiments, it is to be noted that a communication mode is different. For example, in the fourth example embodiment, a communication from the second server apparatus 400_2 to the fourth server apparatus 400_4 in step D2 of FIG. 13 and a communication from the first server apparatus 400_1 to the fourth server apparatus 400_4 in step D5 for verification thereof occur. This is a part of a commincation path required for a multiplication by four-party MPC which enables to detect fraud using 2-out-of-4 replicated secret sharing performed on a ring [symbol] ₂_{ⁿ}. That is, in the fourth example embodiment, when performing bit embedding, anything other than a commincation path required for a multiplication by the MPC as described above is not required. In the first to third example embodiments, in addition to the communication path required for a multiplication by the MPC as described above, additional commincation is required. Therefore, there is a case where the fourth example embodiment may be more efficient depending on certain communication environment. Bit embedding cost in the fourth example embodiment is 16n bits·3 rounds when a large amount of processing are performed in parallel.

### Fifth Example Embodiment

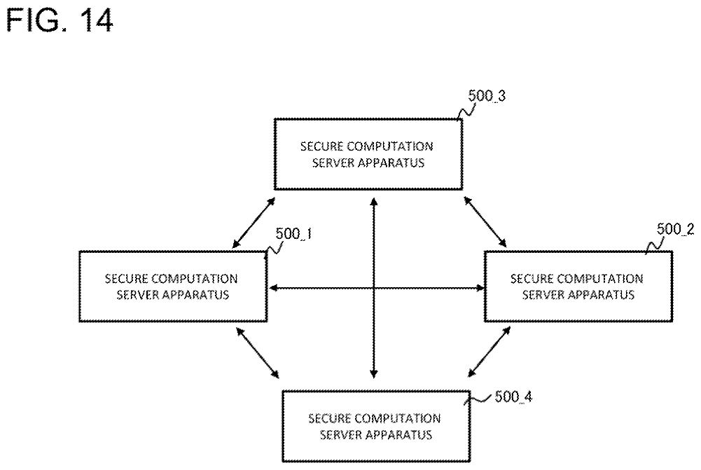

Bit embedding processing system according to a fifth example embodiment will be described Referring to FIG. 14 to FIG. 16.

FIG. 14 is a block diagram illustrating an example of a functional configuration of a bit embedding system according to a fifth example embodiment. The bit embedding processing system according to the fifth example embodiment is an example of a variation of the bit embedding processing system according to the first to fourth example embodiments as described above. In the fifth example embodiment below, the same reference signs are assigned to parts having the same functions as those of the parts previously described in the first to fourth example embodiments, and the description thereof will be omitted.

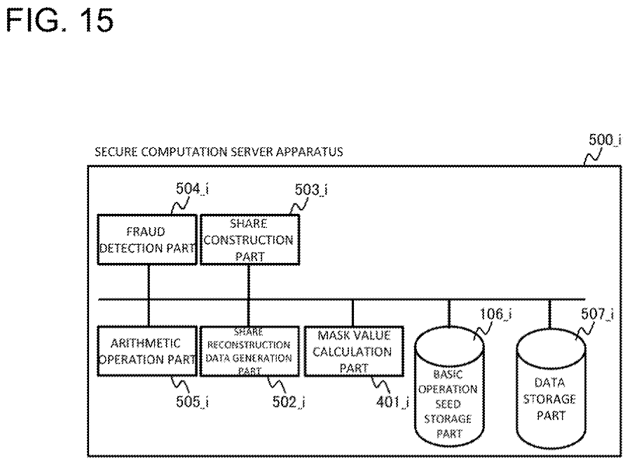

Referring to FIG. 14, the bit embedding processing system according to the fifth example embodiment includes i-th (i=1, 2, 3, and 4) server apparatuses referred to in FIG. 15 described later. In the bit embedding processing system according to the fifth example embodiment, server apparatuses 500_1, 500_2, 500_3, and 500_4 are communicably connected to server apparatuses different from themselves via a network. FIG. 15 is a block diagram illustrating an example of a functional configuration of i-th server apparatus 500_i (i=1, 2, 3, and 4).

As illustrated in FIG. 15, the i-th server apparatus 500_i includes an i-th mask value computation part 401_i, an i-th share reconstruction data generation part 502_i, an i-th share construction part 503_i, an i-th fraud detection part 504_i, an i-th arithmetic operation part 505_i, an i-th basic operation seed storage part 106_i, and an i-th data storage part 507_i. Please note that the i-th mask value computation part 401_i, the i-th share reconstruction data generation part 502_i, the i-th share construction part 503_i, the i-th fraud detection part 504_i, the i-th arithmetic operation part 505_i, the i-th basic operation seed storage part 106_i, and the i-th data storage part 507_i are respectively connected.

In the bit embedding processing system having the above described configuration, for a value x∈ [symbol] ₂, which any of the first to fourth server apparatuses 500_1 to 500_4 has inputted,

a share [x] stored in the first to fourth data storage part 507_1 to 507_4, or
a share [x] which has been inputted from outside that is not the first to fourth server apparatuses 500_1 to 500_4,
[x]ⁿ is computed without a value x being known from the input or a value under a computation process and stored in the first to fourth data storage part 507_1 to 507_4. Shares of the above computation result may be transmitted and received by the first to fourth server apparatuses 500_1 to 500_4 and restored. Alternatively, shares may be transmitted to outside that is not the first to fourth server apparatuses 500_1 to 500_4 and restored.

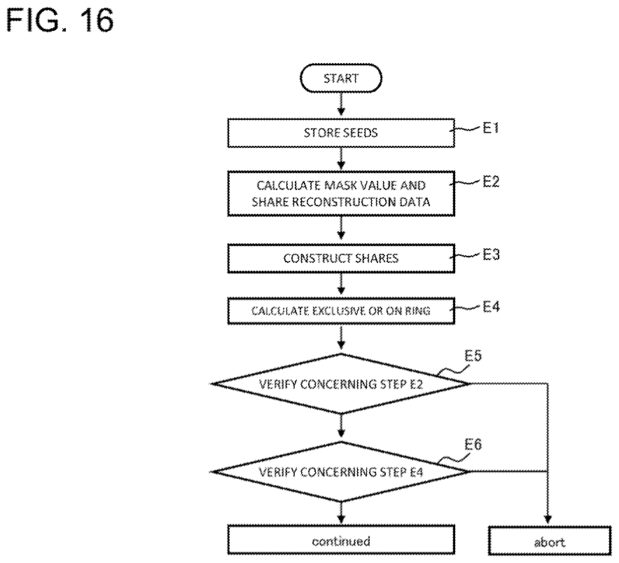

Next, an operation of the bit embedding processing system and the first to fourth server apparatuses 500_1 to 500_4 in the fifth example embodiment will be described in detail. FIG. 16 is a flowchart illustrating an example of an operation concerning bit embedding of the first to fourth server apparatuses 500_1 to 500_4.

### (Step E1)

Each basic operation seed storage part 106_1, 1062, 1063, and 106_4 respectively stores

(seed₁,seed₂,seed₄),
(seed₂,seed₃,seed₄),
(seed₃,seed₁,seed₄), and
(seed₁,seed₂,seed₃).

Each server apparatus 500_1 to 500_4 commonly shares pseudo-random functions h and h′.

### Where,

seedᵢ,seed′ᵢ∈{0,1}*(i=1,2,3)

The pseudo-random functions are given as:

h:{0,1}*×{0,1}*→{0,1},h′:{0,1}*×{0,1}*→{0,1}ⁿ

Each data storage part 507_1 to 507_4 respectively stores

[x]₁=(x₁,x₂),[x]₂=(x₂,x₃),[x]₃=(x₃,x₁),[x]₄=(x₁⊕x₂,x₂⊕x₃)

where [x]ᵢ(i=1, 2, 3, 4) is [x] stored in each data storage part 507i.

It is intended to create a situation in which with respect to seedᵢ, in the server apparatuses 500_i (i=1, 2, 3, 4), one participant cannot compute an output of h and other three participants can compute an output of h.

As far as this situation can be created, handling of seedᵢ is not particularly limited. In the present description, seedᵢ is just an example.

### (Step E2)

A first, second, and third mask value computation part 401_1, 401_2, and 4013 compute r=h(sid∥1,seed₄) and stores r in a first, second, and third data storage part 507_1, 507_2, and 507_3. The second mask value computation part 401_2 takes out a share [x]₂=(x₂,x₃) from the data storage part 507_2. The second mask value computation part 4012 generates y=x₂⊕r and transmits y to the fourth server apparatus 500_4. The fourth server apparatus 500_4 stores y in the fourth data storage part 407_4.

Where,

sid∈{0,1}*

where sid is, for example, a counter and it is commonly shared among each server apparatus 500_1 to 500_4.

The first share reconstruction data generation part 502_1, the second share reconstruction data generation part 502_2, and the third share reconstruction data generation part 502_3 respectively acquire seed₄ from the first basic operation seed storage part 106_1, the second basic operation seed storage part 106_2, and the third basic operation seed storage part 106_3.

Then, they generate r′=h′(sid∥3,seed₄).

The second share reconstruction data generation part 502_2 transmits r′ to the second share construction part 503_2. The first share reconstruction data generation part 502_1 transmits r′ to the first share construction part 503_1.

The third share reconstruction data generation part 502_3 takes out x₃ from the third data storage part 507_3 and transmits r′−(x₃−2r′) to the fourth share construction part 403_4.

Where,

sid∈{0,1}*

where sid is, for example, a counter and it is commonly shared among each server apparatus 500_1 to 500_4.

### (Step E3)

Each share construction part 503_1, 503_2, 503_3, and 503_4 respectively takes out

([x]₁,r,r′),([x]₂,r,r′),([x]₃,r,r′), and ([x]₄,y,r′−(x₃−2′r))

from each data storage part 507_1, 507_2, 507_3, and 507_4.
Each share construction part 503_1, 503_2, 503_3, and 503_4 constructs shares using the values transmitted in step E2 as described above by the following 12 expressions:

[x₁⊕r]₁ⁿ=(x₁⊕r,0)

[x₁⊕r]₂ⁿ=(0,0)

[x₁⊕r]₃ⁿ=(0,x₁⊕r)

[x₁⊕r]₄ⁿ=(x₁⊕x₂⊕y,0)

[x₂⊕r]₁ⁿ=(0,x₂⊕r)

[x₂⊕r]₂ⁿ=(x₂⊕r,0)

[x₂⊕r]₃ⁿ=(0,0)

[x₂⊕r]₄ⁿ=(y,y)

[x₃]₁ⁿ=(r′,r′)

[x₃]₂ⁿ=(r′,x₃−2r′)

[x₃]₃ⁿ=(x₃−2r′,r′)

[x₃]₄ⁿ=(0,r′−(x₃−2r′)).

[x₁]ᵢⁿ, [x₂]ᵢⁿ and [x₃]ᵢⁿ are stored in each i-th data storage part 507_i.

In this way, each share reconstruction data generation part 502_i generates a random number used for reconstruction of shares. At that time, each share reconstruction data generation part 502_i generates the random number, when generating share reconstruction data for a value x′, such that two in x′₁, x′₂, and x′₃ become zero where x′=x′₁+x′₂+x′₃ holds. In the example of the step E3 above, for example, if x′=x₁⊕r, then a random number is generated such that x′₂=x′₃=0 holds.

### (Step E4)

Each i-th arithmetic operation part 505_i computes an exclusive OR processing on a ring XOR_on_Ring as follows by communicating with each other. XOR_on_Ring is a processing in which

[a₁]ⁿ and [a₂]ₙ (a₁,a₂ ∈ [symbol] ₂) are inputted and
[a₁⊕a₂]ₙ is outputted. For example, the followings hold.

[x₁⊕x₂]ⁿ←XOR_on_Ring([x₁]ⁿ,[x₂]ⁿ)

[x₁⊕x₂⊕x₃]ⁿ←XOR_on_Ring([x₁⊕x₂]ⁿ,[x₃]ⁿ)

where,

x₁⊕x₂⊕x₃=x

Each i-th arithmetic operation part 505_1 stores [x]ⁿ in each data storage part 507_i.

### (Step E5)

In a first server apparatus 500_1, in the same way as the second server apparatus 500_2 in step E3 as described above, a first mask value computation part 401_1 generates y′=x₂⊕r and transmits y′ to a fourth server apparatus 500_4.

The fourth server apparatus 500_4 stores y′ in a fourth data storage part 507_4.
A fourth fraud detection part 504_4 takes out y, and y′ from the fourth data storage part 507_4 and verifies whether or not y=y′.

If y=y′ holds, the fourth fraud detection part 504_4 broadcasts a character string of “success” to each server apparatus 500_1, 500_2, and 500_3 to proceed to a next step.

If y=y′ does not hold, the fourth fraud detection part 504_4 broadcasts a character string of “abort” to each server apparatus 500_1, 500_2, and 500_3 to abort a protocol.

Next, a second share reconstruction data generation part 502_2 takes out r′ and x₃ from a second data storage part 507_2.

Then, the second share reconstruction data generation part 502_2 transmits r′−(x₃−2r′) to the fourth fraud detection part 504_4.
The fourth fraud detection part 504_4 takes out [x₃]₄=(0,x_{3,2}) stored in the fourth data storage part 507_4 and verifies whether or not x_{3,2}=r′−(x₃−2r′) holds.

If the above holds, the fourth fraud detection part 504_4 broadcasts a character string of “success” to each server apparatus 500_1, 500_2, 500_3, and 500_4 to proceed to a next step.

If the above does not hold, the fourth fraud detection part 504_4 broadcasts a character string of “abort” to each server apparatus 500_1, 500_2, 500_3, and 500_4 to abort a protocol.

When performing a large amount of bit embedding processing in parallel, regarding y′ and r′|(x₃−2r′), it may be possible to verify by transmitting hash values of ones acquired by concatenating respective values and comparing the hash values each other. In this case, it can be considered that communication amount of hash values may be negligible with respect to computation amount of the entire processing.

### (Step E6)

Each i-th fraud detection part 504_i performs the fraud detection by using data transmitted and received in XOR_on_Ring in step E4 as described above and comparing them. The first to fourth server apparatuses 500_1, 500_2, 500_3, and 500_4 on which fraud has not been detected broadcast a character string of “success” to each server apparatus. The first to fourth server apparatuses 500_1, 500_2, 500_3, and 500_4 on which fraud has been detected broadcast a character string of “abort” to each server apparatus to abort a protocol. This is realized by four-party secure computation which enables to detect fraud as described above. Step E6 can be executed in parallel with step E5 as described above.

In the fifth example embodiment as described, the same effects as those in the first to fourth example embodiments can be obtained. However, with respect to the first effect of the first to fourth example embodiments, a communication mode is different in the fifth example embodiment. Therefore, there is a case where the fifth example embodiment may be more efficiently performed depending on communication environment. Please note that, when performing processing concerning the fraud detection in parallel, in the fifth example embodiment, 12n bits·3 rounds is required as commincation cost for bit embedding.

### [Hardware Configuration]

Next, a hardware configuration of a secure computation server which forms a secure computation system will be described.

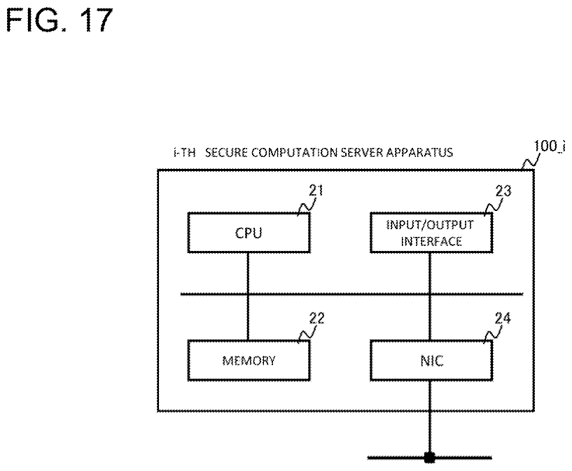

FIG. 17 is a diagram illustrating an example of a hardware configuration of an i-th secure computation server 100_i. The i-th secure computation server 100_i is achieved by so-called an information processing apparatus (computer) and has a configuration as exemplified in FIG. 17. For example, the i-th secure computation server 100_i includes a CPU (Central Processing Unit) 21, a memory 22, an input/output interface 23, and an NIC (Network Interface Card) 24 and so on which are mutually connected via internal bus.

However, the configuration as illustrated in FIG. 17 is not intended to limit a hardware configuration of the i-th secure computation server 100_i. The i-th secure computation server 100_i may include any hardware which is not shown. The number of CPUs included in the i-th secure computation server 100_i is also not intended to be limited to the example as illustrated in FIG. 17, and, for example, a plurality of CPUs 21 may be included in the i-th secure computation server 100_i.

The memory 22 includes a RAM (Random Access Memory), a ROM (Read Only Memory), an auxiliary storage device (hard disk, etc.), and so on.

The input/output interface 23 is an interface of an input/output apparatus which is not shown. The input/output apparatus includes, for example, a display, an operating device, and so on. The display is, for example, a liquid crystal display and so on. The operating device is, for example, a keyboard, a mouse, and so on.

A function of the i-th secure computation server 100_i is realized by a processing module as described above. The processing module is, for example, realized in such a manner that the CPU 21 executes a program stored in the memory 22. The program can be updated by downloading through a network or using a storage medium on which the program is recorded. The processing module as described above may be realized by a semiconductor chip. That is, a function performed by the processing module as described above may be sufficient to be realized by any hardware or a software executed using a hardware.

### MODIFICATION EXAMPLES

A configuration or an operation of a secure computation verification system described in the first to fifth example embodiments are examples and various modifications are possible. For example, although, in the example embodiments as described above, a case where the four secure computation servers 100_1 to 100_4 are equal to each other has been descried, one server apparatus may be assigned as a representative server. In this case, the representative server may control input/output of data (sharing input data and distribution thereof and decoding computation results) used for secure computation.

In flowcharts used in the description as described above, a plurality of processes (processing) are described in order, but an execution order of the processes performed in each example embodiment is not limited to the order as described. In each example embodiment, it is possible to change the order of processes illustrated in drawings within a scope which does not interfere contents, for example, in such way that each processing is performed in parallel, and so on. Each example embodiment as described above can be combined as long as contents do not contradict each other. That is, any combination of each example embodiments as described above may be included as further example embodiments.

In flowcharts used in the description as described above, a plurality of processes (processing) are described in order, but an execution order of the processes performed in each example embodiment is not limited to the order as described. In each example embodiment, it is possible to change the order of processes illustrated in drawings within a scope which does not interfere contents, for example, in such way that each processing is performed in parallel, and so on. Each example embodiment as described above can be combined as long as contents do not contradict each other. That is, any combination of each example embodiments as described above may be included as further example embodiments.

Although industrial applicability of the present invention is clear from the description as above, the present invention is preferred, for example, to efficiently realize computation of a mixed circuit, such as biometric template matching or a statistical operation, in four-party MPC which enables to detect fraud using 2-out-of-4 replicated secret sharing performed on a ring [symbol] ₂_{ⁿ}.

A part or all of example embodiments described above can also be described as the following notes, but not limited thereto.

### [Note 1]

See the information processing apparatus according to the above first aspect.

### [Note 2]

The information processing apparatus preferably according to note 1, wherein the share reconstruction data generation part generates a random number used for reconstruction of the share.

### [Note 3]

The information processing apparatus preferably according to note 2, wherein the share reconstruction data generation part generates a random number, when generating the share reconstruction data for a value x′ such that two values in x₁′, x₂′, and x₃′ become equal, where x′=x₁′+x₂′+x₃′.

### [Note 4]

The information processing apparatus preferably according to note 2, wherein the share reconstruction data generation part generates a random number, when generating the share reconstruction data for a value x′ such that two in x₁′, x₂′, and x₃′, become zero, where x′=x₁′+x₂′+x₃′.

### [Note 5]

The information processing apparatus preferably according to note 2, wherein the share reconstruction data generation part generates a random number, when generating the share reconstruction data for a value x such that two values in x₁, x₂, and x₃, where x=x₁+x₂+x₃, become equal, and
generates a random number r, when generating the share reconstruction data for a value x′ such that x₁′=x′+r, x₂′=0, and x₃′=−r hold, where x′=x₁′+x₂′+x₃′.

### [Note 6]

The information processing apparatus preferably according to any one of notes 1 to 5, further comprising a fraud detection part which detects presence or absence of a fraud doer by using the share for the bit embedding.

### [Note 7]

The information processing apparatus preferably according to note 6, further comprising an arithmetic operation part which computes an exclusive OR on a ring using shares for the bit embedding, wherein the fraud detection part detects presence or absence of the fraud doer by using data transmitted and received when computing the exclusive OR.

### [Note 8]

The information processing apparatus preferably according to note 7, wherein detection of presence or absence of the fraud doer using shares for the bit embedding, and detection of presence or absence of the fraud doer by using data transmitted and received when computing the exclusive OR.

### [Note 9]

The information processing apparatus preferably according to any one of notes 1 to 8, further comprising: a mask value computation part which computes a mask value to mask a share and transmits the share masked by the computed mask value to the other apparatuses, wherein the share construction part constructs a share for the bit embedding using the transmitted mask value.

### [Note 10]

The information processing apparatus preferably according to note 6 referring preferably to any one of notes 6 to 8, wherein the fraud detection part detects presence or absence of a fraud doer using the mask value.

### [Note 11]

The information processing apparatus preferably according to any one of notes 6 to 10, wherein the fraud detection part, when detecting a fraud doer, aborts a protocol concerning the secure computing.

### [Note 12]

See the secure computation method according to the above second aspect.

### [Note 13]

See the program according to the above third aspect.

The above Notes 12 and 13 can be expanded in the same way as the Note 1 is expanded to the Notes 2 to 11.

Each disclosure of the cited above Patent Literatures and so on is incorporated herein by reference thereto. Variations and adjustments of the example embodiments and examples are possible within the scope of the overall disclosure (including the claims) of the present invention and based on the basic technical concept of the present invention. Various combinations and selections (including partial deletion) of various disclosed elements (including each of the elements in each of the claims, example embodiments, examples, drawings, etc.) are possible within the scope of the entire disclosure of the present invention. Namely, the present invention of course includes various variations and modifications that could be made by those skilled in the art according to the overall disclosure including the claims and the technical concept. In particular, with respect to numerical ranges described herein, any numerical values or small range(s) included in the ranges should be construed as being expressly described even if not particularly mentioned.

### SIGNS LIST

10 Information processing apparatus
11, 106_1, 206_1, 106_i, 206_i Basic operation seed storage part
12, 102_1, 202_1, 302_1, 402_1, 502_1, 102_i to 502_i Share reconstruction data generation part
13, 103_1, 203_1, 303_1, 403_1, 503_1, 103_i to 503_i Share construction part
21 CPU (Central Processing Unit)
22 Memory
23 Input/output interface
24 NIC (Network Interface Card)
100_1 to 100_4, 200_1 to 200_4, 300_1 to 300_4, 400_1 to 400_4, 500_1 to 500_4, 100_i to 500_i Secure computation server apparatus
401_1, 401_i Mask value computation part
104_1, 204_1, 304_1, 404_1, 504_1, 104_i to 504_i Fraud detection part
105_1, 205_1, 305_1, 405_1, 505_1, 105_i to 505_i Arithmetic operation part
107_1, 207_1, 307_1, 407_1, 507_1, 107_i to 507_i Data storage part

What is claimed is:

1. An information processing apparatus comprising:
at least one processor;
a memory storing therein program instruction executable by the processor; and
a storage that stores a seed to generate a random number used for performing an operation on a share,
wherein the at least one processor is configured to:
generate, by using the seed, share reconstruction data for reconstructing a share used when performing bit embedding; and
construct a share for bit embedding by using at least the share reconstruction data.

2. The information processing apparatus according to claim 1, wherein the at least one processor is configured to,
in generating the share reconstruction data, generate a random number used for reconstruction of the share.

3. The information processing apparatus according to claim 2, wherein the at least one processor is configured to,
when generating the share reconstruction data for a value x′, generate the random number such that two values out of x1′, x2′ and x3′ become equal, wherein x1′, x2′ and x3′ satisfy x′=x1′+x2′+x3′.

4. The information processing apparatus according to claim 2, wherein the at least one processor is configured to,
when generating the share reconstruction data for a value x, generate the random number such that two out of x1′, x2′ and x3′ become zero, wherein x1′, x2′ and x3′ satisfy x′=x1′+x2′+x3′.

5. The information processing apparatus according to claim 2, wherein the at least one processor is configured to,
when generating the share reconstruction data for a value x, generate the random number such that two values out of x1, x2 and x3 become equal, wherein x1, x2 and x3 satisfy x=x1+x2+x3, and
when generating the share reconstruction data for a value x′, generate the random number r such that x₁′=x′+r, x₂′=0, and x₃′=−r hold, wherein x1′, x2′ and x3′ satisfy x′=x1′+x2′+x3′.

6. The information processing apparatus according to claim 1, wherein the at least one processor is configured to
detect presence or absence of a fraud doer by using the share for the bit embedding.

7. The information processing apparatus according to claim 6, wherein the at least one processor is configured to:
compute an exclusive OR on a ring using the share for the bit embedding, and
detect presence or absence of the fraud doer by using data transmitted and received when computing the exclusive OR.

8. The information processing apparatus according to claim 7, wherein the at least one processor is configured to perform in parallel,
detecting presence or absence of the fraud doer using the share for the bit embedding, and
detecting presence or absence of the fraud doer by using data transmitted and received when computing the exclusive OR.

9. A secure computation method in an information processing apparatus that comprises a basic operation seed storage part that stores a seed to generate a random number used when performing an operation on a share, the method comprising:
generating, by using the seed, share reconstruction data for reconstructing a share used when performing bit embedding; and
constructing a share for bit embedding by using at least the share reconstruction data.

10. A non-transitory computer-readable medium storing therein a program that causes a computer mounted on an information processing apparatus that comprises a basic operation seed storage part that stores a seed to generate a random number used when performing operation concerning shares, to execute processing, comprising:
generating, by using the seed, share reconstruction data for reconstructing a share used when performing bit embedding; and
constructing a share for bit embedding by using at least the share reconstruction data.

11. The information processing apparatus according to claim 1, comprising
a network interface card to communicate with second to fourth information processing apparatuses via a communication network, wherein the information processing apparatus and the second to fourth information processing apparatuses constitute respectively first to fourth servers implementing four-party multi-party computation using 2-out-of-4 replicated secret sharing.

12. The secure computation method according to claim 9, comprising
generating a random number, as the share reconstruction data, used for reconstruction of the share.

13. The secure computation method according to claim 12, comprising when
generating the share reconstruction data for a value x′, generating the random number such that two values out of x1′, x2′ and x3′ become equal, wherein x1′, x2′ and x3′ satisfy x′=x1′+x2′+x3′.

14. The secure computation method according to claim 12, comprising
when generating the share reconstruction data for a value x, generating the random number such that two out of x1′, x2′ and x3′ become zero, wherein x1′, x2′ and x3′ satisfy x′=x1′+x2′+x3′.

15. The secure computation method according to claim 12, comprising
when generating the share reconstruction data for a value x, generating the random number such that two values out of x1, x2 and x3 become equal, wherein x1, x2 and x3 satisfy x=x1+x2+x3, and
when generating the share reconstruction data for a value x′, generating a random number r such that x₁′=x′+r, x₂′=0, and x₃′=−r hold, wherein x1′, x2′ and x3′ satisfy x′=x1′+x2′+x3′.

16. The secure computation method according to claim 9, further comprising
detecting presence or absence of a fraud doer, based on the share for the bit embedding.

17. The secure computation method according to claim 16, further comprising;
computing an exclusive OR on a ring using the share for the bit embedding; and
detecting presence or absence of the fraud doer by using data transmitted and received when computing the exclusive OR.

18. The non-transitory computer-readable medium according to claim 10, storing therein the program causing the computer to execute processing comprising
generating a random number, as the share reconstruction data, used for reconstruction of the share.

19. The non-transitory computer-readable medium according to claim 18, storing therein the program causing the computer to execute processing comprising
when generating the share reconstruction data for a value x′, generating the random number such that two values out of x1′, x2′ and x3′ become equal, wherein x1′, x2′ and x3′ satisfy x′=x1′+x2′+x3′.

20. The non-transitory computer-readable medium according to claim 18, storing therein the program causing the computer to execute processing comprising
when generating the share reconstruction data for a value x, generating the random number such that two out of x1′, x2′ and x3′ become zero, wherein x1′, x2′ and x3′ satisfy x′=x1′+x2′+x3′.
